(19) United States
(12) Patent Application Publication
(10) Pub. No.: US 2025/0106387 A1
(43) Pub. Date: Mar. 27, 2025

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Zhipin DENG, Beijing (CN); Kai Zhang, Los Angeles, CA (US); Li Zhang, Los Angeles, CA (US)

(21) Appl. No.: 18/974,257

(22) Filed: Dec. 9, 2024

Related U.S. Application Data
(63) Continuation of application No. PCT/CN2023/099558, filed on Jun. 10, 2023.

(30) Foreign Application Priority Data
Jun. 10, 2022 (WO) PCT/CN2022/098221

(51) Int. Cl. H04N 19/105; H04N 19/172; H04N 19/70

(52) U.S. Cl. CPC H04N 19/105; H04N 19/172; H04N 19/70

(57) ABSTRACT

Embodiments of the present disclosure provide a solution for video processing. A method for video processing is proposed. The method comprises: determining, for a conversion between a video unit of a video and a bitstream of the video unit, whether a template based processing is applied to the video unit, wherein the template based processing is based on at least one template in at least one of: a current picture or a reference picture of the video unit; and performing the conversion based on the determining.

### CROSS-REFERENCE TO RELATED APPLICATIONS

This application is a continuation of International Application No. PCT/CN2023/099558, filed on Jun. 10, 2023, which claims the benefit of International Application No. PCT/CN2022/098221, filed on Jun. 10, 2022. The entire contents of these applications are hereby incorporated by reference in their entireties.

### FIELDS

Embodiments of the present disclosure relates generally to video processing techniques, and more particularly, to interaction of reconstruction reordered intra block copy (IBC) (RRIBC) and template based methodologies in image/video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video unit, whether a template based processing is applied to the video unit, wherein the template based processing is based on at least one template in at least one of: a current picture or a reference picture of the video unit; and performing the conversion based on the determining. Compared with conventional technologies, it can improve coding efficiency.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining whether a template based processing is applied to a video unit of the video, wherein the template based processing is based on at least one template in at least one of: a current picture or a reference picture of the video unit; and generating a bitstream based on the determining.

In a fifth aspect, a method for storing a bitstream of a video is proposed. The method comprises: determining whether a template based processing is applied to a video unit of the video, wherein the template based processing is based on at least one template in at least one of: a current picture or a reference picture of the video unit; generating a bitstream based on the determining; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a current CTU processing order and available samples in current and left CTU;

FIG. 5 illustrates the transform skip residual coding process;

FIG. 6 illustrates example of a block coded in palette mode;

FIGS. 7A and 7B illustrate examples of subblock-based index map scanning for palette, with FIG. 7A for horizontal scanning and FIG. 7B for vertical scanning;

FIG. 8 illustrates an example decoding flowchart with ACT;

FIG. 9 illustrates an example intra template matching search area used;

FIG. 10 illustrates IBC reference region depending on current CU position;

FIG. 11A illustrates a BV adjustment for horizontal flip;

FIG. 11B illustrates a BV adjustment for vertical flip;

FIG. 12 illustrates spatial candidates used for IBC merge/AMVP candidate list;

FIG. 13 illustrates template and reference samples for the template;

FIG. 14A illustrates a schematic diagram of a first example of sample reordering based template matching;

FIG. 14B illustrates a schematic diagram of a second example of sample reordering based template matching;

FIG. 14C illustrates a schematic diagram of a third example of sample reordering based template matching;

FIG. 14D illustrates a schematic diagram of a fourth example of sample reordering based template matching;

FIG. 14E illustrates a schematic diagram of a fifth example of sample reordering based template matching;

FIG. 14F illustrates a schematic diagram of a sixth example of sample reordering based template matching;

FIG. 14G illustrates a schematic diagram of a seventh example of sample reordering based template matching;

FIG. 14H illustrates a schematic diagram of an eighth example of sample reordering based template matching;

FIG. 15A illustrates a reference template and a current template for the template cost calculation when the motion candidate is RRIBC coded, where the motion candidate is RRIBC coded with horizontally flip;

FIG. 15B illustrates a reference template and a current template for the template cost calculation when the motion candidate is RRIBC coded, where the motion candidate is RRIBC coded with vertically flip;

FIG. 16 illustrates a flowchart of a method for video processing in accordance with embodiments of the present disclosure; and

FIG. 17 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

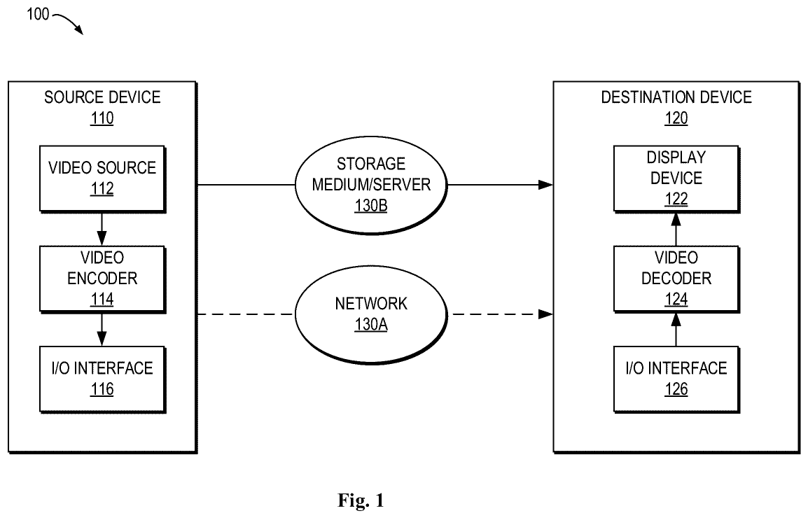

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

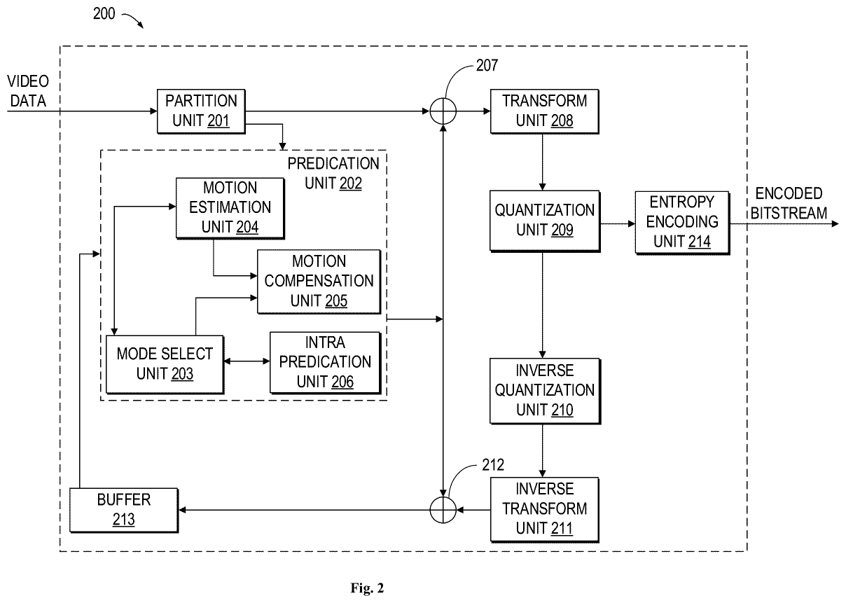

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

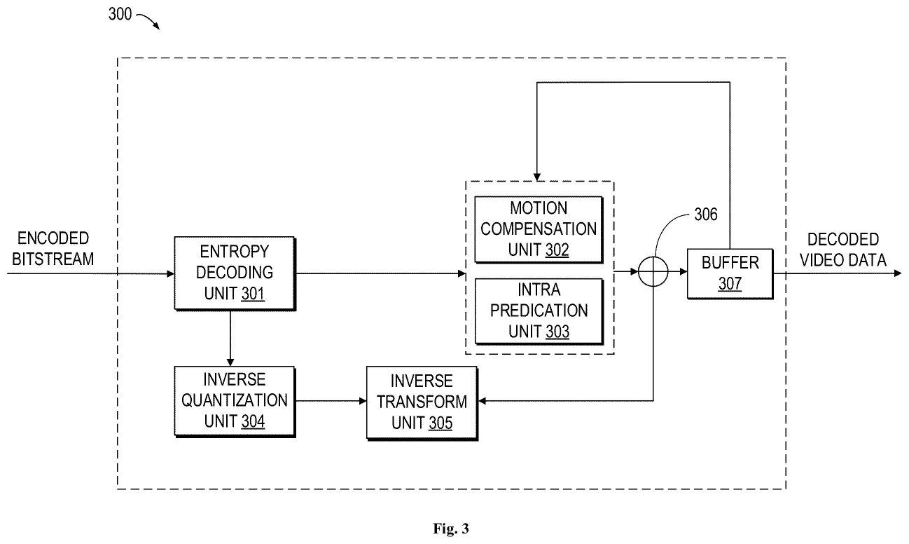

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This present disclosure is related to video coding technologies. Specifically, it is about the interaction between RRIBC and other coding tools in image/video coding. It may be applied to the existing video coding standard like HEVC, VVC, and etc. It may be also applicable to future video coding standards or video codec.

### 2. INTRODUCTION

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC [1] standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM [2] are then updated after every meeting. The VVC project achieved technical completion (FDIS) at the July 2020 meeting [3].

In January 2021, JVET established an Exploration Experiment (EE), targeting at enhanced compression efficiency beyond VVC capability with novel traditional algorithms. Soon later, ECM [4] was built as the common software base for longer-term exploration work towards the next generation video coding standard.

### 2.1 Existing Screen Content Coding Tools

### 2.1.1 Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:
IBC skip/merge mode: a merge candidate index is used to indicate which of the block vectors in the list from neighboring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### 2.1.1.1 IBC Reference Region

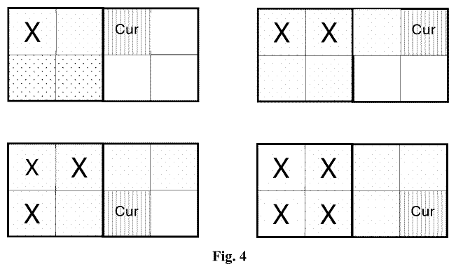

To reduce memory consumption and decoder complexity, the IBC in VVC allows only the reconstructed portion of the predefined area including the region of current CTU and some region of the left CTU. FIG. 4 illustrates the reference region of IBC Mode, where each block represents 64×64 luma sample unit.

Depending on the location of the current coding CU location within the current CTU, the following applies:
If current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.
If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU, it can only refer to the already reconstructed samples in the current CTU, using CPR mode.

This restriction allows the IBC mode to be implemented using local on-chip memory for hardware implementations.

2.1.1.2 IBC Interaction with Other Coding Tools

The interaction between IBC mode and other inter coding tools in VVC, such as pairwise merge candidate, history based motion vector predictor (HMVP), combined intra/inter prediction mode (CIIP), merge mode with motion vector difference (MMVD), and geometric partitioning mode (GPM) are as follows:
IBC can be used with pairwise merge candidate and HMVP. A new pairwise IBC merge candidate can be generated by averaging two IBC merge candidates. For HMVP, IBC motion is inserted into history buffer for future referencing.
IBC cannot be used in combination with the following inter tools: affine motion, CIIP, MMVD, and GPM.
IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:
IBC shares the same process as in regular MV merge including with pairwise merge candidate and history based motion predictor, but disallows TMVP and zero vector because they are invalid for IBC mode.
Separate HMVP buffer (5 candidates each) is used for conventional MV and IBC.
Block vector constraints are implemented in the form of bitstream conformance constraint, the encoder needs to ensure that no invalid vectors are present in the bitsream, and merge shall not be used if the merge candidate is invalid (out of range or 0). Such bitstream conformance constraint is expressed in terms of a virtual buffer as described below.
For deblocking, IBC is handled as inter mode.
If the current block is coded using IBC prediction mode, AMVR does not use quarter-pel; instead, AMVR is signaled to only indicate whether MV is inter-pel or 4 integer-pel.
The number of IBC merge candidates can be signalled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hIbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min (ctbSize, 64) in each dimension, Wᵥ=min (ctbSize, 64).

The virtual IBC buffer, ibcBuf is maintained as follows.
At the beginning of decoding each CTU row, refresh the whole ibcBuf with an invalid value−1.
At the beginning of decoding a VPDU (xVPDU, yVPDU) relative to the top-left corner of the picture, set the ibcBuf [x][y]=−1, with x=xVPDU % wIbcBuf, . . . , xVPDU % wIbcBuf+Wᵥ−1; y=yVPDU % ctbSize, . . . , yVPDU % ctbSize+Wᵥ−1.
After decoding a CU contains (x, y) relative to the top-left corner of the picture, set

ibcBuf[x % wIbcBuf][y % ctbSize]=recSample[x][y]

For a block covering the coordinates (x, y), if the following is true for a block vector bv=(bv[0], bv[1]), then it is valid; otherwise, it is not valid:

ibcBuf[(x+bv[0])% wIbcBuf][(y+bv[1])% ctbSize] shall not be equal to −1.

### 2.1.2 Block Differential Pulse Coded Modulation (BDPCM)

VVC supports block differential pulse coded modulation (BDPCM) for screen content coding. At the sequence level, a BDPCM enable flag is signalled in the SPS; this flag is signalled only if the transform skip mode (described in the next section) is enabled in the SPS.

When BDPCM is enabled, a flag is transmitted at the CU level if the CU size is smaller than or equal to MaxTsSize by MaxTsSize in terms of luma samples and if the CU is intra coded, where MaxTsSize is the maximum block size for which the transform skip mode is allowed. This flag indicates whether regular intra coding or BDPCM is used.

If BDPCM is used, a BDPCM prediction direction flag is transmitted to indicate whether the prediction is horizontal or vertical. Then, the block is predicted using the regular horizontal or vertical intra prediction process with unfiltered reference samples. The residual is quantized and the difference between each quantized residual and its predictor, i.e. the previously coded residual of the horizontal or vertical (depending on the BDPCM prediction direction) neighbouring position, is coded.

For a block of size M (height)×N (width), let r_{i,j}, 0≤i≥M−1, 0≤j≤N−1 be the prediction residual. Let Q(r_{i,j}), 0≤i≤M−1, 0<<N−1 denote the quantized version of the residual r_{i,j}. BDPCM is applied to the quantized residual values, resulting in a modified M×N array \tilde{R} with elements \tilde{r}_{i,j}, where \tilde{r}_{i,j} is predicted from its neighboring quantized residual value. For vertical BDPCM prediction mode, for 0≤j≤(N−1), the following is used to derive \tilde{r}_{i,j}:

$${\tilde{r}}_{i , j} = \{ \begin{matrix}Q ( {r}_{i , j} ) , & i = 0 \\ Q ( {r}_{i , j} ) - Q ( {r}_{( i - 1 ) , j} ) , & 1 \leq i \leq ( M - 1 )\end{matrix} \qquad ( 2 - 1 )$$

For horizontal BDPCM prediction mode, for 0≤i≤(M−1), the following is used to derive \tilde{r}_{i,j}:

$${\tilde{r}}_{i , j} = \{ \begin{matrix}Q ( {r}_{i , j} ) , & j = 0 \\ Q ( {r}_{i , j} ) - Q ( {r}_{i , ( j - 1 )} ) , & 1 \leq j \leq ( N - 1 )\end{matrix} \qquad ( 2 - 2 )$$

At the decoder side, the above process is reversed to compute Q(r_{i,j}), 0≤i≥M−1, 0≤j≤N−1, as follows:

$$Q ( {r}_{i , j} ) = {\sum }_{k = 0}^{i} {\tilde{r}}_{k , j} , if vertical BDPCM is used \qquad ( 2 - 3 )$$

$$Q ( {r}_{i , j} ) = {\sum }_{k = 0}^{j} {\tilde{r}}_{i , k} , if horizontal BDPCM is used \qquad ( 2 - 4 )$$

The inverse quantized residuals, Q⁻¹(Q(r_{i,j})), are added to the intra block prediction values to produce the reconstructed sample values.

The predicted quantized residual values \tilde{r}_{i,j}, are sent to the decoder using the same residual coding process as that in transform skip mode residual coding. For lossless coding, if slice_ts_residual_coding_disabled_flag is set to 1, the quantized residual values are sent to the decoder using regular transform residual coding as described in 2.2.2. In terms of the MPM mode for future intra mode coding, horizontal or vertical prediction mode is stored for a BDPCM-coded CU if the BDPCM prediction direction is horizontal or vertical, respectively. For deblocking, if both blocks on the sides of a block boundary are coded using BDPCM, then that particular block boundary is not deblocked.

### 2.1.3 Residual Coding for Transform Skip Mode

VVC allows the transform skip mode to be used for luma blocks of size up to MaxTsSize by MaxTsSize, where the value of MaxTsSize is signaled in the PPS and can be at most 32. When a CU is coded in transform skip mode, its prediction residual is quantized and coded using the transform skip residual coding process. This process is modified from the transform coefficient coding process described in 2.2.2. In transform skip mode, the residuals of a TU are also coded in units of non-overlapped subblocks of size 4×4. For better coding efficiency, some modifications are made to customize the residual coding process towards the residual signal's characteristics. The following summarizes the differences between transform skip residual coding and regular transform residual coding:
Forward scanning order is applied to scan the subblocks within a transform block and also the positions within a subblock;
no signalling of the last (x, y) position;
coded_sub_block_flag is coded for every subblock except for the last subblock when all previous flags are equal to 0;
sig_coeff_flag context modelling uses a reduced template, and context model of sig_coeff_flag depends on top and left neighbouring values;
context model of abs_level_gt1 flag also depends on the left and top sig_coeff_flag values;
par_level_flag using only one context model;
additional greater than 3, 5, 7, 9 flags are signalled to indicate the coefficient level, one context for each flag;
rice parameter derivation using fixed order=1 for the binarization of the remainder values;
context model of the sign flag is determined based on left and above neighbouring values and the sign flag is parsed after sig_coeff_flag to keep all context coded bins together.

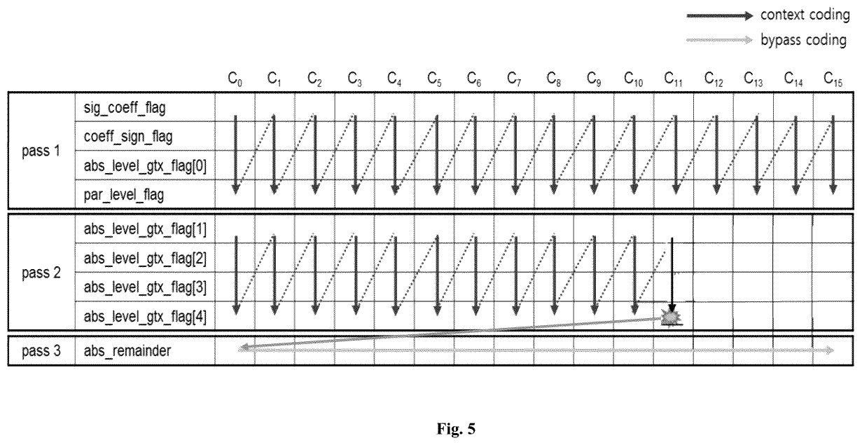

For each subblock, if the coded_subblock_flag is equal to 1 (i.e., there is at least one non-zero quantized residual in the subblock), coding of the quantized residual levels is performed in three scan passes (see FIG. 5):
First scan pass: significance flag (sig_coeff_flag), sign flag (coeff_sign_flag), absolute level greater than 1 flag (abs_level_gtx_flag[0]), and parity (par_level_flag) are coded. For a given scan position, if sig_coeff_flag is equal to 1, then coeff_sign_flag is coded, followed by the abs_level_gtx_flag[0] (which specifies whether the absolute level is greater than 1). If abs_level_gtx_flag[0] is equal to 1, then the par_level_flag is additionally coded to specify the parity of the absolute level.
Greater-than-x scan pass: for each scan position whose absolute level is greater than 1, up to four abs_level_gtx_flag[i] for i=1 . . . 4 are coded to indicate if the absolute level at the given position is greater than 3, 5, 7, or 9, respectively.
Remainder scan pass: The remainder of the absolute level abs_remainder are coded in bypass mode. The remainder of the absolute levels are binarized using a fixed rice parameter value of 1.

The bins in scan passes #1 and #2 (the first scan pass and the greater-than-x scan pass) are context coded until the maximum number of context coded bins in the TU have been exhausted. The maximum number of context coded bins in a residual block is limited to 1.75*block_width*block_height, or equivalently, 1.75 context coded bins per sample position on average. The bins in the last scan pass (the remainder scan pass) are bypass coded. A variable, RemCcbs, is first set to the maximum number of context-coded bins for the block and is decreased by one each time a context-coded bin is coded. While RemCcbs is larger than or equal to four, syntax elements in the first coding pass, which includes the sig_coeff_flag, coeff_sign_flag, abs_level_gt1_flag and par_level_flag, are coded using context-coded bins. If RemCcbs becomes smaller than 4 while coding the first pass, the remaining coefficients that have yet to be coded in the first pass are coded in the remainder scan pass (pass #3).

After completion of first pass coding, if RemCcbs is larger than or equal to four, syntax elements in the second coding pass, which includes abs_level_gt3_flag, abs_level_gt5_flag, abs_level_gt7_flag, and abs_level_gt9_flag, are coded using context coded bins. If the RemCcbs becomes smaller than 4 while coding the second pass, the remaining coefficients that have yet to be coded in the second pass are coded in the remainder scan pass (pass #3).

FIG. 5 illustrates the transform skip residual coding process. The star marks the position when context coded bins are exhausted, at which point all remaining bins are coded using bypass coding.

Further, for a block not coded in the BDPCM mode, a level mapping mechanism is applied to transform skip residual coding until the maximum number of context coded bins has been reached. Level mapping uses the top and left neighbouring coefficient levels to predict the current coefficient level in order to reduce signalling cost. For a given residual position, denote absCoeff as the absolute coefficient level before mapping and absCoeffMod as the coefficient level after mapping. Let X₀ denote the absolute coefficient level of the left neighbouring position and let X₁ denote the absolute coefficient level of the above neighbouring position. The level mapping is performed as follows:

```
pred = max(X0, X1);
if (absCoeff = = pred)
  absCoeffMod = 1;
else
  absCoeffMod = (absCoeff < pred) ? absCoeff + 1 : absCoeff;
```

Then, the absCoeffMod value is coded as described above. After all context coded bins have been exhausted, level mapping is disabled for all remaining scan positions in the current block.

### 2.1.4 Palette Mode

In VVC, the palette mode is used for screen content coding in all of the chroma formats supported in a 4:4:4 profile (that is, 4:4:4, 4:2:0, 4:2:2 and monochrome). When palette mode is enabled, a flag is transmitted at the CU level if the CU size is smaller than or equal to 64×64, and the amount of samples in the CU is greater than 16 to indicate whether palette mode is used. Considering that applying palette mode on small CUs introduces insignificant coding gain and brings extra complexity on the small blocks, palette mode is disabled for CU that are smaller than or equal to 16 samples. A palette coded coding unit (CU) is treated as a prediction mode other than intra prediction, inter prediction, and intra block copy (IBC) mode.

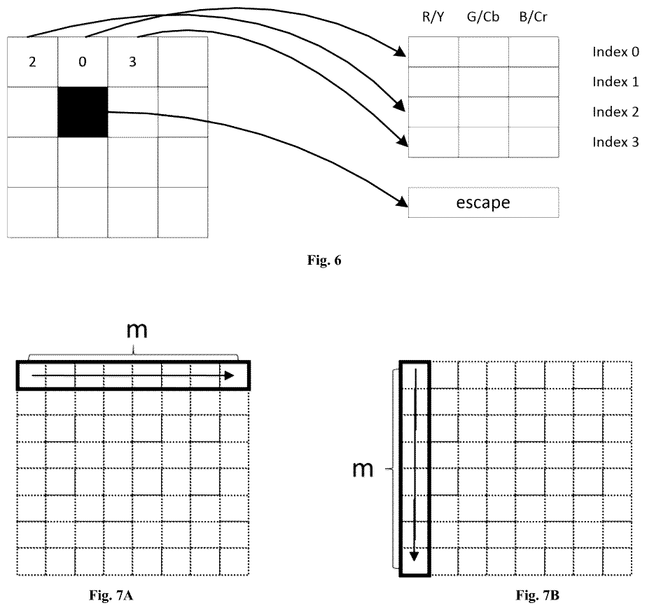

If the palette mode is utilized, the sample values in the CU are represented by a set of representative colour values. The set is referred to as the palette. For positions with sample values close to the palette colours, the palette indices are signalled. It is also possible to specify a sample that is outside the palette by signalling an escape symbol. For samples within the CU that are coded using the escape symbol, their component values are signalled directly using (possibly) quantized component values. This is illustrated in FIG. 6 that shows example of a block coded in palette mode. The quantized escape symbol is binarized with fifth order Exp-Golomb binarization process (EG5).

For coding of the palette, a palette predictor is maintained. The palette predictor is initialized to 0 at the beginning of each slice for non-wavefront case. For WPP case, the palette predictor at the beginning of each CTU row is initialized to the predictor derived from the first CTU in the previous CTU row so that the initialization scheme between palette predictors and CABAC synchronization is unified. For each entry in the palette predictor, a reuse flag is signalled to indicate whether it is part of the current palette in the CU. The reuse flags are sent using run-length coding of zeros. After this, the number of new palette entries and the component values for the new palette entries are signalled. After encoding the palette coded CU, the palette predictor will be updated using the current palette, and entries from the previous palette predictor that are not reused in the current palette will be added at the end of the new palette predictor until the maximum size allowed is reached. An escape flag is signaled for each CU to indicate if escape symbols are present in the current CU. If escape symbols are present, the palette table is augmented by one and the last index is assigned to be the escape symbol.

In a similar way as the coefficient group (CG) used in transform coefficient coding, a CU coded with palette mode is divided into multiple line-based coefficient group, each consisting of m samples (i.e., m=16), where index runs, palette index values, and quantized colors for escape mode are encoded/parsed sequentially for each CG. Same as in HEVC, horizontal or vertical traverse scan can be applied to scan the samples, as shown in FIGS. 7A and 7B, that show subblock-based index map scanning for palette, with FIG. 7A for horizontal scanning and FIG. 7B for vertical scanning.

The encoding order for palette run coding in each segment is as follows: For each sample position, 1 context coded bin run_copy_flag=0 is signalled to indicate if the pixel is of the same mode as the previous sample position, i.e., if the previously scanned sample and the current sample are both of run type COPY_ABOVE or if the previously scanned sample and the current sample are both of run type INDEX and the same index value. Otherwise, run_copy_flag=1 is signaled. If the current sample and the previous sample are of different modes, one context coded bin copy_above_palette_indices_flag is signaled to indicate the run type, i.e., INDEX or COPY_ABOVE, of the current sample. Here, decoder doesn't have to parse run type if the sample is in the first row (horizontal traverse scan) or in the first column (vertical traverse scan) since the INDEX mode is used by default. With the same way, decoder doesn't have to parse run type if the previously parsed run type is COPY_ABOVE. After palette run coding of samples in one coding pass, the index values (for INDEX mode) and quantized escape colors are grouped and coded in another coding pass using CABAC bypass coding. Such separation of context coded bins and bypass coded bins can improve the throughput within each line CG.

For slices with dual luma/chroma tree, palette is applied on luma (Y component) and chroma (Cb and Cr components) separately, with the luma palette entries containing only Y values and the chroma palette entries containing both Cb and Cr values. For slices of single tree, palette will be applied on Y, Cb, Cr components jointly, i.e., each entry in the palette contains Y, Cb, Cr values, unless when a CU is coded using local dual tree, in which case coding of luma and chroma is handled separately. In this case, if the corresponding luma or choma blocks are coded using palette mode, their palette is applied in a way similar to the dual tree case (this is related to non-4:4:4 coding and will be further explained in 2.1.4.1).

For slices coded with dual tree, the maximum palette predictor size is 63, and the maximum palette table size for coding of the current CU is 31. For slices coded with dual tree, the maximum predictor and palette table sizes are halved, i.e., maximum predictor size is 31 and maximum table size is 15, for each of the luma palette and the chroma palette. For deblocking, the palette coded block on the sides of a block boundary is not deblocked.

### 2.1.4.1 Palette Mode for Non-4:4:4 Content

Palette mode in VVC is supported for all chroma formats in a similar manner as the palette mode in HEVC SCC.

For non-4:4:4 content, the following customization is applied:
1. When signaling the escape values for a given sample position, if that sample position has only the luma component but not the chroma component due to chroma subsampling, then only the luma escape value is signaled. This is the same as in HEVC SCC.
2. For a local dual tree block, the palette mode is applied to the block in the same way as the palette mode applied to a single tee block with two exceptions:
   a. The process of palette predictor update is slightly modified as follows. Since the local dual tree block only contains luma (or chroma) component, the predictor update process uses the signalled value of luma (or chroma) component and fills the “missing” chroma (or luma) component by setting it to a default value of (1<< (component bit depth−1)).
   b. The maximum palette predictor size is kept at 63 (since the slice is coded using single tree) but the maximum palette table size for the luma/chroma block is kept at 15 (since the block is coded using separate palette).
3. For palette mode in monochrome format, the number of colour components in a palette coded block is set to 1 instead of 3.

### 2.1.4.2 Encoder Algorithm for Palette Mode

At the encoder side, the following steps are used to produce the palette table of the current CU
1. First, to derive the initial entries in the palette table of the current CU, a simplified K-means clustering is applied. The palette table of the current CU is initialized as an empty table. For each sample position in the CU, the SAD between this sample and each palette table entry is calculated and the minimum SAD among all palette table entries is obtained. If the minimum SAD is smaller than a pre-defined error limit, errorLimit, then the current sample is clustered together with the palette table entry with the minimum SAD. Otherwise, a new palette table entry is created. The threshold errorLimit is QP-dependent and is retrieved from a look-up table containing 57 elements covering the entire QP range. After all samples of the current CU have been processed, the initial palette entries are sorted according to the number of samples clustered together with each palette entry, and any entry after the 31^{st} entry is discarded.
2. In the second step, the initial palette table colours are adjusted by considering two options: using the centroid of each cluster from step 1 or using one of the palette colours in the palette predictor. The option with lower rate-distortion cost is selected to be the final colours of the palette table. If a cluster has only a single sample and the corresponding palette entry is not in the palette predictor, the corresponding sample is converted to an escape symbol in the next step.
3. A palette table thus generated contains some new entries from the centroids of the clusters in step 1, and some entries from the palette predictor. So this table is reordered again such that all new entries (i.e. the centroids) are put at the beginning of the table, followed by entries from the palette predictor.

Given the palette table of the current CU, the encoder selects the palette index of each sample position in the CU. For each sample position, the encoder checks the RD cost of all index values corresponding to the palette table entries, as well as the index representing the escape symbol, and selects the index with the smallest RD cost using the following equation:

$$RD cost = distortion \times ( isChroma ? 0.8 : 1 ) + lambda \times bypass coded bits \qquad ( 2 - 5 )$$

After deciding the index map of the current CU, each entry in the palette table is checked to see if it is used by at least one sample position in the CU. Any unused palette entry will be removed.

After the index map of the current CU is decided, trellis RD optimization is applied to find the best values of run_copy_flag and run type for each sample position by comparing the RD cost of three options: same as the previously scanned position, run type COPY_ABOVE, or run type INDEX. When calculating the SAD values, sample values are scaled down to 8 bits, unless the CU is coded in lossless mode, in which case the actual input bit depth is used to calculate the SAD. Further, in the case of lossless coding, only rate is used in the rate-distortion optimization steps mentioned above (because lossless coding incurs no distortion).

### 2.1.5 Adaptive Color Transform

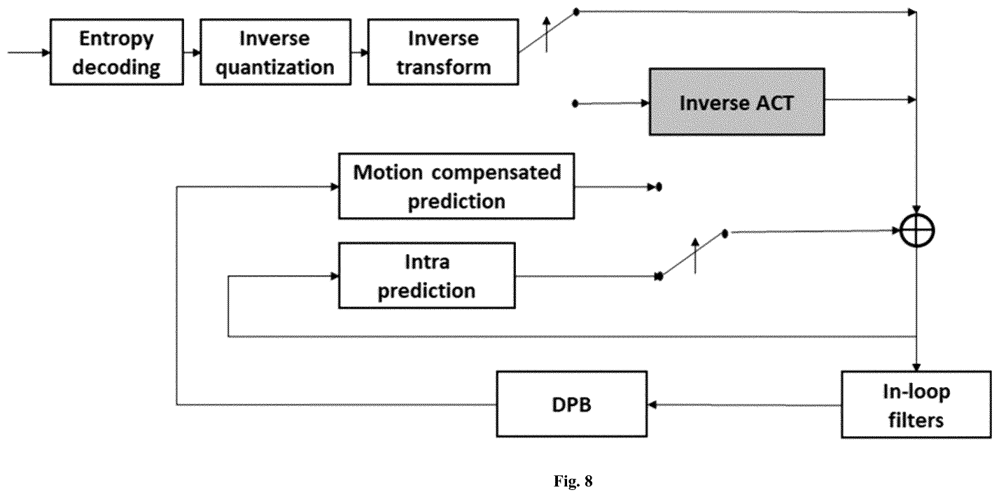

In HEVC SCC extension, adaptive color transform (ACT) was applied to reduce the redundancy between three color components in 444 chroma format. The ACT is also adopted into the VVC standard to enhance the coding efficiency of 444 chroma format coding. Same as in HEVC SCC, the ACT performs in-loop color space conversion in the prediction residual domain by adaptively converting the residuals from the input color space to YCgCo space. FIG. 8 illustrates the decoding flowchart with the ACT being applied. Two color spaces are adaptively selected by signaling one ACT flag at CU level. When the flag is equal to one, the residuals of the CU are coded in the YCgCo space; otherwise, the residuals of the CU are coded in the original color space. Additionally, same as the HEVC ACT design, for inter and IBc CUs, the ACT is only enabled when there is at least one non-zero coefficient in the CU. For intra CUs, the ACT is only enabled when chroma components select the same intra prediction mode of luma component, i.e., DM mode.

### 2.1.5.1 ACT Mode

In HEVC SCC extension, the ACT supports both lossless and lossy coding based on lossless flag (i.e., cu_transquant_bypass_flag). However, there is no flag signalled in the bitstream to indicate whether lossy or lossless coding is applied. Therefore, YCgCo-R transform is applied as ACT to support both lossy and lossless cases. The YCgCo-R reversible colour transform is shown as below.

| Forward Conversion: | Backward Conversion: | |
|---|---|---|
| GBR to YCgCo | YCgCo to GBR | |
| Co = R − B; | t = Y − (Cg >> 1) | (2-6) |
| t = B + (Co >> 1); | G = Cg + t | |
| Cg = G − t; | B = t − (Co >> 1) | |
| Y = t + (Cg >> 1); | R = Co + B | |

Since the YCgCo-R transform are not normalized. To compensate the dynamic range change of residuals signals before and after color transform, the QP adjustments of (−5, 1, 3) are applied to the transform residuals of Y, Cg and Co components, respectively. The adjusted quantization parameter only affects the quantization and inverse quantization of the residuals in the CU. For other coding processes (such as deblocking), original QP is still applied.

Additionally, because the forward and inverse color transforms need to access the residuals of all three components, the ACT mode is always disabled for separate-tree partition and ISP mode where the prediction block size of different color component is different. Transform skip (TS) and block differential pulse coded modulation (BDPCM), which are extended to code chroma residuals, are also enabled when the ACT is applied.

### 2.1.5.2 ACT Fast Encoding Algorithms

To avoid brutal R-D search in both the original and converted color spaces, the following fast encoding algorithms are applied in the VTM reference software to reduce the encoder complexity when the ACT is enabled.
The order of RD checking of enabling/disabling ACT is dependent on the original color space of input video. For RGB videos, the RD cost of ACT mode is checked first; for YCbCr videos, the RD cost of non-ACT mode is checked first. The RD cost of the second color space is checked only if there is at least one non-zero coefficient in the first color space.
The same ACT enabling/disabling decision is reused when one CU is obtained through different partition path. Specifically, the selected color space for coding the residuals of one CU will be stored when the CU is coded at the first time. Then, when the same CU is obtained by another partition path, instead of checking the RD costs of the two spaces, the stored color space decision will be directly reused.
The RD cost of a parent CU is used to decide whether to check the RD cost of the second color space for the current CU. For instance, if the RD cost of the first color space is smaller than that of the second color space for the parent CU, then for the current CU, the second color space is not checked.
To reduce the number of tested coding modes, the selected coding mode is shared between two color spaces. Specifically, for intra mode, the preselected intra mode candidates based on SATD-based intra mode selection are shared between two color spaces. For inter and IBC modes, block vector search or motion estimation is performed only once. The block vectors and motion vectors are shared by two color spaces.

### 2.1.6 Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

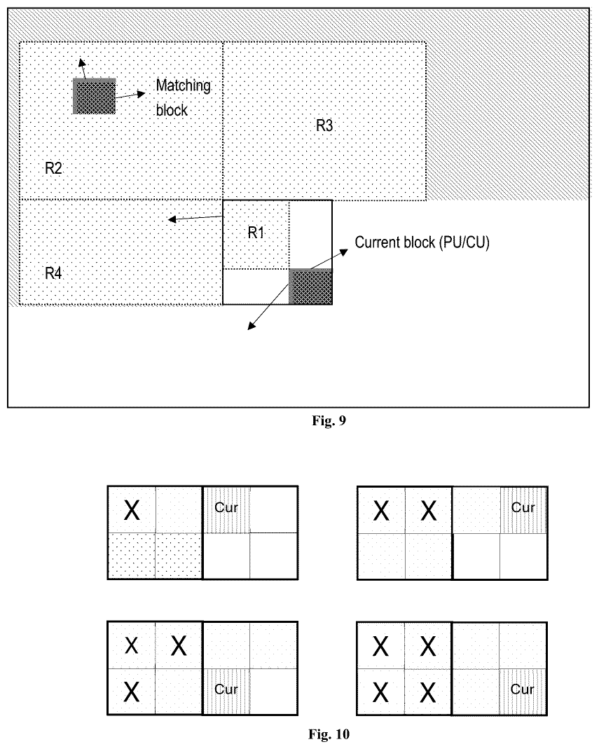

The prediction signal is generated by matching the L-shaped causal neighbor of the current block with another block in a predefined search area in FIG. 9 consisting of:
R1: current CTU
R2: top-left CTU
R3: above CTU
R4: left CTU

SAD is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$SearchRange\_w = a * BlkW$$

$$SearchRange\_h = a * BlkH$$

Where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

2.1.7 IBC with Template Matching (IBC-TM)

In ECM-5.0, Template Matching with IBC is used for both IBC merge mode and IBC AMVP mode.

The IBC-TM merge list has been modified compared to the one used by regular IBC merge mode such that the candidates are selected according to a pruning method with a motion distance between the candidates as in the regular TM merge mode. The ending zero motion fulfillment (which is a nonsense regarding Intra coding) has been replaced by motion vectors to the left (−W, 0), top (0,−H) and top-left (−W,−H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

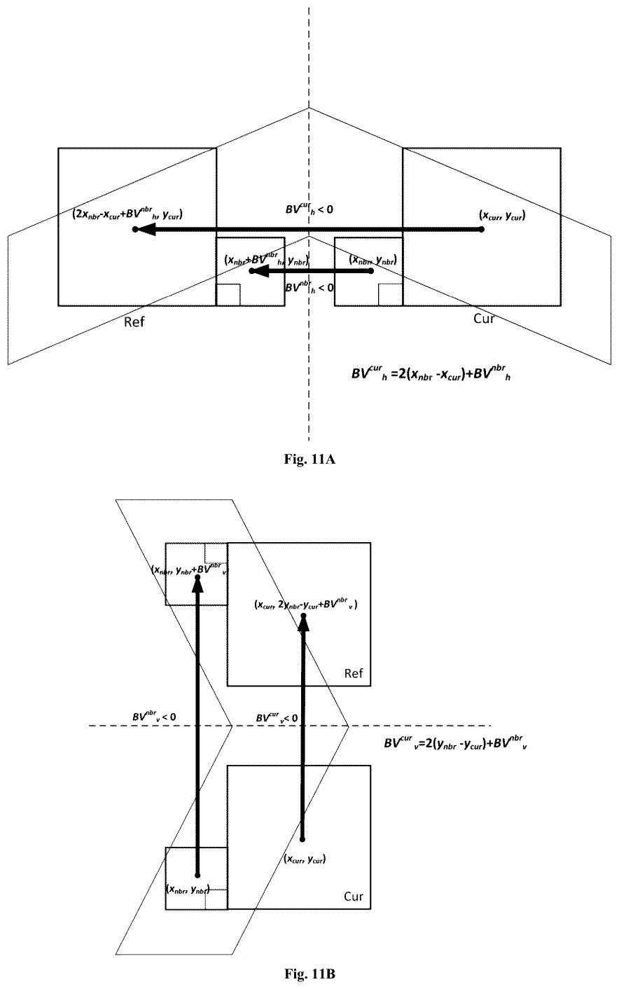

The Template Matching refinement for both IBC-TM merge and AMVP modes is quite simple since IBC motion vectors are constrained (i) to be integer and (ii) within a reference region as shown in FIG. 10. So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

### 2.1.8 Enlarged HMVP Table for IBC

In ECM-5.0, the HMVP table size for IBC is increased to 25. After up to 20 IBC merge candidates are derived with full pruning, they are reordered together. After reordering, the first 6 candidates with the lowest template matching costs are selected as the final candidates in the IBC merge list.

### 2.1.9 Block Vector Difference Binarization

In ECM-4.0, Block Vector Difference (BVD) shares the same binarization method with Motion Vector Difference (MVD). For each component, greater than 0, greater than 1 flags are signalled followed by the bypass coded remaining magnitude binarized with EG1 code.

In ECM-5.0, the greater than 1 flag is removed and the first 5 bins of the EG1 prefix are context coded, all other bins are kept bypass coded.

### 2.1.10 Reconstruction-Reordered IBC (RRIBC)

At the JVET-Z meeting, a Reconstruction-Reordered IBC (RR-IBC) mode was proposed for screen content video coding. When it is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

To better utilize the symmetry property, a flip-aware BV adjustment approach is applied to refine the block vector candidate. FIG. 11A shows BV adjustment for horizontal flip and FIG. 11B shows BV adjustment for vertical flip, respectively For example, as shown in FIG. 11A and FIG. 11B, (x_{nbr}, y_{nbr}) and (x_{cur}, y_{cur}) represent the coordinates of the center sample of the neighbouring block and the current block, respectively, BV^{nbr} and BV^{cur} denotes the BV of the neighbouring block and the current block, respectively. Instead of directly inheriting the BV from a neighbouring block, the horizontal component of BV^{cur} is calculated by adding a motion shift to the horizontal component of BV^{nbr} (denoted as BVnbrh) in case that the neighbouring block is coded with a horizontal flip, i.e., BV^{cur}ₕ=2 (x_{nbr}−x_{cur})+BV^{nbr}ₕ. Similarly, the vertical component of BV^{cur} is calculated by adding a motion shift to the vertical component of BV^{nbr} (denoted as BV^{nbr}ᵥ) in case that the neighbouring block is coded with a vertical flip, i.e., BV^{cur}ᵥ=2 (y_{nbr}−y_{cur})+BV^{nbr}ᵥ.

### 2.1.11 Modifications of IBC Merge/AMVP List Construction Using Adaptive Reordering-Based Motion Compensation (ARMC)

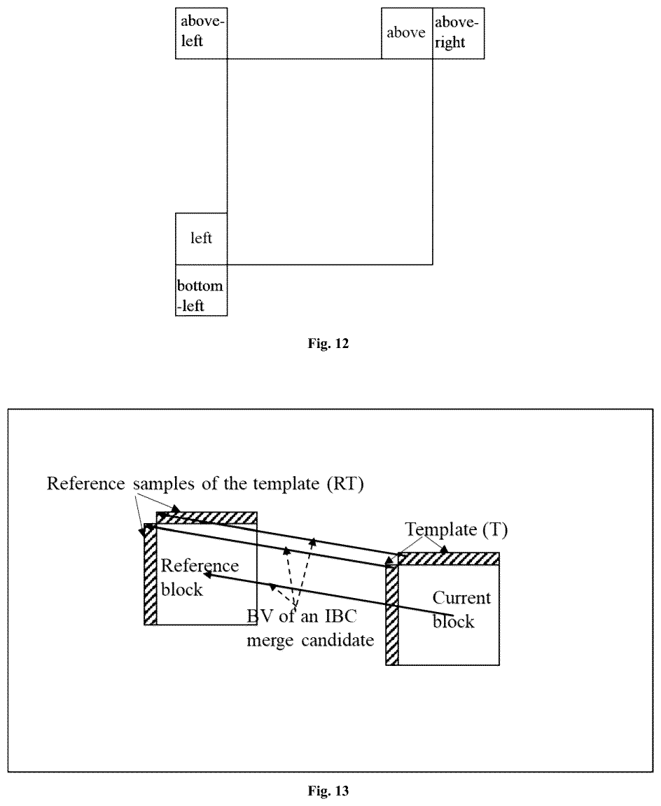

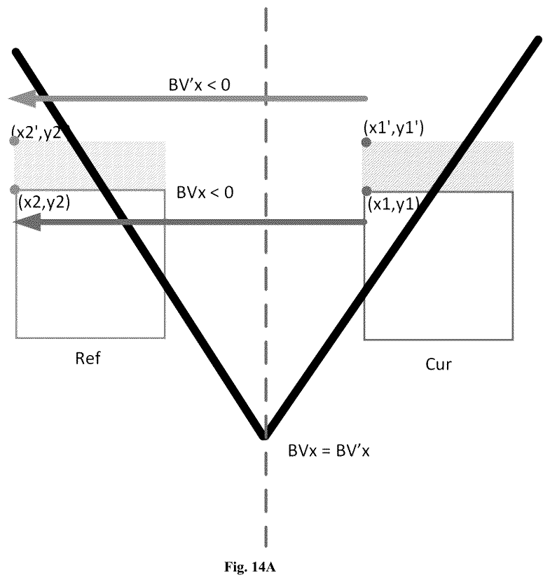

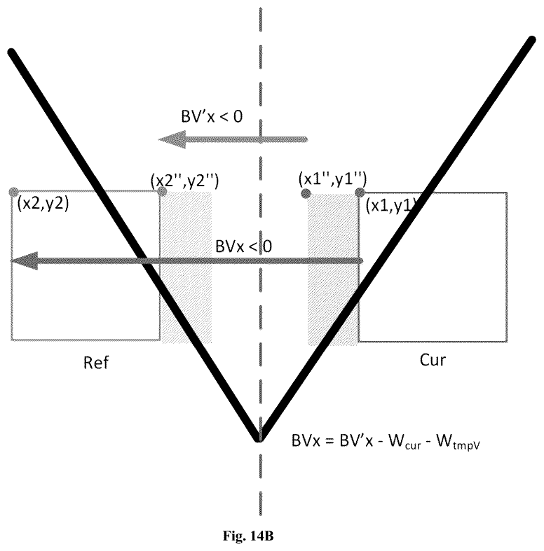

In ECM, the IBC merge/AMVP list construction is modified with the following changes:
1) Only if an IBC merge/AMVP candidate is valid, it can be inserted into the IBC merge/AMVP candidate list.
2) Above-right, bottom-left, and above-left spatial candidates (as shown in FIG. 12 that shows spatial candidates used for IBC merge/AMVP candidate list) and one pairwise average candidate can be added into the IBC merge/AMVP candidate list.
3) ARMC-TM is extended to IBC merge list known as adaptive reordering of merge candidates with template matching for IBC (ARMC-TM-IBC). Template and reference samples of the template are shown in FIG. 13.

### 2.2 Previous Related Solutions

### 2.2.1 Reordering of Reconstruction Sample

The detailed embodiments below should be considered as examples to explain general concepts. These embodiments should not be interpreted in a narrow way. Furthermore, these embodiments can be combined in any manner.

In the following disclosure, a block may refer to a coding block (CB), a coding unit (CU), a prediction block (PB), a prediction unit (PU), a transform block (TB), a transform unit (TU), a sub-block, a sub-CU, a coding tree unit (CTU), a coding tree block (CTB), or a coding group (CG).

In the following disclosure, a region may refer to any video unit, such as a picture, a slice or a block. A region may also refer to a non-rectangular region, such as a triangular.

In the following disclosure, W and H represents the width and height of a mentioned rectangular region.
1. It is proposed that the samples in a region may be reordered.
   a. Reordering of samples may be defined as following: Suppose the sample at position (x, y) in a region before reordering is denoted as S(x, y), and the sample at position (x, y) in a region after reordering is denoted as R(x, y). It is required that R(x, y)=S (f(x, y), g(x, y)), wherein (f(x, y), g(x, y)) is a position in the region, f and g are two functions.
      i. For example, it is required that there is at least one position (x, y) satisfying that (f(x, y), g(x, y)) is not equal to (x, y).
   b. The samples in a region to be reordered may be
      i. Original samples before encoding
      ii. Prediction samples
      iii. Reconstruction samples
      iv. Transformed samples (transformed coefficients)
      v. Samples before inverse-transform (coefficients before inverse-transform)
      vi. Samples before deblocking filtering
      vii. Samples after deblocking filtering
      viii. Samples before SAO processing
      ix. Samples after SAO processing
      x. Samples before ALF processing
      xi. Samples after ALF processing
      xii. Samples before post processing
      xiii. Samples after post processing
   c. In one example, reordering may be applied at more than one stage.
      i. For example, at least two of these samples listed in bullet 1.b may be reordered.
         1) For example, different reordering methods may be applied on the two kinds of samples.
         2) For example, the same reordering method may be applied on the two kinds of samples.
   d. In one example, reordering may be a horizontal flip. For example, f(x, y)=P−x, g(x, y)=y. E.g. P=W−1.
   e. In one example, reordering may be a vertical flip. For example, f(x, y)=x, g(x, y)=Q−y. E.g. Q=H−1.
   f. In one example, reordering may be a horizontal-vertical flip. For example, f(x, y)=P−x, g(x, y)=Q−y. E.g. P=W−1 and Q=H−1.
   g. In one example, reordering may be a shift. For example, f(x, y)=(P+x) % W, g(x, y)=(Q+y) % H, wherein P and Q are integers.
   h. In one example, reordering may be a rotation.
   i. In one example, there is at least one (x, y) satisfying(x, y) is equal to (f(x,y), g(x,y)).
   j. In one example, whether to and/or how to reorder the samples may be signaled from the encoder to the decoder, such as in SPS/sequence header/PPS/picture header/APS/slice header/sub-picture/tile/CTU line/CTU/CU/PU/TU.
      i. For example, a first flag is signaled to indicate whether reordering is applied.
         1) E.g., the first flag may be coded with context coding.
      ii. For example, a second syntax element (such as a flag) is signaled to indicate which reordering method is used (such as horizontal flip or vertical flip).
         1) E.g. the second syntax element is signaled only if it is indicated that reordering is applied.
         2) E.g., the second syntax element may be coded with context coding.
2. It is proposed that whether to and/or how to reorder the samples may depend on coding information.
   a. In one example, whether to and/or how to reorder the samples may be derived depending on coding information at picture level/slice level/CTU level/CU level/PU level/TU level.
   b. In one example, the coding information may comprise:
      i. Dimensions of the region.
      ii. Coding mode of the region (such as inter, intra or IBC).
      iii. Motion information (such as motion vectors and reference indices).
      iv. Intra-prediction mode (such as angular intra-prediction mode, Planar or DC).
      v. Inter-prediction mode (such as affine prediction, bi-prediction/uni-prediction, merge mode, combined inter-intra prediction (CIIP), merge with motion vector difference (MMVD), temporal motion vector prediction (TMVP), sub-TMVP).
      vi. Quantization parameter (QP).
      vii. Coding tree splitting information such as coding tree depth.
      viii. Color format and/or color component.
3. It is proposed that at least one parsing or decoding procedure other than the reordering procedure may depend on whether to and/or how to reorder samples.
   a. For example, a syntax element may be signaled conditionally based on whether reordering is applied or not.
   b. For example, different scanning order may be used based on whether to and/or how to reorder samples.
   c. For example, deblocking filtering/SAO/ALF may be used based on whether to and/or how to reorder samples.
4. In one example, samples may be processed by at least one auxiliary procedure before or after the resampling process. Some possible auxiliary procedures may comprise: (combination may be allowed)
   a. For example, at least one sample may be added by an offset.
   b. For example, at least one sample may be multiplied by a factor.
   c. For example, at least one sample may be clipped.
   d. For example, at least one sample may be filtered.
   e. For example, at least one sample X may be modified to be T(X), wherein T is a function.
5. In one example, for a block coded with IBC mode.
   a. For example, a first flag is signaled to indicate whether reconstruction samples should be reordered.
      i. E.g., the first flag may be coded with context coding.
   b. For example, a second flag may be signaled to indicate whether reconstruction samples should be flipped horizontally or vertically.
      i. E.g. the second flag is signaled only if the first flag is true.
      ii. E.g., the second flag may be coded with context coding.
         2.2.2 on Sample Reordering-Application Condition, and the Interaction with Other Procedures

The detailed embodiments below should be considered as examples to explain general concepts. These embodiments should not be interpreted in a narrow way. Furthermore, these embodiments can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

It is noted that the terminologies mentioned below are not limited to the specific ones defined in existing standards. Any variance of the coding tool is also applicable.
1. About the application condition of sample reordering (e.g., the 1st and related issues), the following methods are proposed:
   a. Whether a reordering process is applied on a reconstruction/original/prediction block may be dependent on coded information of a video unit.
   a. For example, it may depend on the prediction method.
   b. For example, if a video unit is coded with to one or more modes/techniques as listed below, the reordering process may be applied to the video unit. Otherwise, reordering process is disallowed.
      i. Intra block copy (a.k.a., IBC)
      ii. Current picture referencing (a.k.a., CPR)
      iii. Intra template matching (a.k.a., IntraTM)
      iv. IBC template matching (or template matching based IBC mode)
      v. Merge based coding
      vi. AMVP based coding
   c. For example, it may depend on block dimensions (such as block width and/or height).
   d. For example, if the dimensions W×H of the video unit conform to one or more rules as listed below, the reordering process may be applied to the video unit. Otherwise, reordering process is disallowed.
      i. if W>=T1 and/or H>=T2
      ii. if W<=T1 and/or H<=T2
      iii. if W>T1 and/or H>T2
      iv. if W<T1 and/or H<T2
      v. if W×H>=T
      vi. if W×H>T
      vii. if W×H<=T
      viii. if W×H<T
2. About what kind of samples are reordered and the interaction with other procedures (e.g., the 2th and related issues), the following methods are proposed:
   a. A possible sample reordering method may refer to one or more processes as followings:
      a. Reshaper domain samples (e.g., obtained based on LMCS method) of a video unit may be reordered.
         i. For example, reshaper domain luma samples (e.g., obtained based on luma mapping of the LMCS method) of a video unit may be reordered.
   b. The original domain (rather than LMCS reshaper domain) samples of a video unit may be reordered.
      i. For example, original domain chroma samples of a video unit may be reordered.
      ii. For example, original domain luma samples of a video unit may be reordered.
   c. Reconstruction samples of a video unit may be reordered.
      i. For example, reconstruction samples of the video unit may be reordered right after adding decoded residues to predictions.
      ii. For example, reshaper domain luma reconstruction samples of the video unit may be reordered.
      iii. For example, original domain luma reconstruction samples of the video unit may be reordered.
      iv. For example, original domain chroma reconstruction samples of the video unit may be reordered.
   d. Inverse luma mapping of LMCS process may be applied based on reordered reconstruction samples.
   e. Loop filter process (e.g., luma/chroma bilateral filter, luma/chroma SAO, CCSAO, luma/chroma ALF, CCALF, etc.) may be applied based on reordered reconstruction samples.
      i. For example, loop filter process may be applied based on original domain (rather than LMCS reshaper domain) reordered reconstruction samples.
   f. Distortion calculation (e.g., SSE computation between original samples and reconstruction samples) may be based on reordered reconstruction samples.
      i. For example, distortion calculation may be based on original domain reordered reconstruction samples.
   g. Original samples of a video unit may be reordered.
      i. For example, the reshaper domain original luma samples of a video unit may be reordered.
      ii. For example, the original domain original luma samples of a video unit may be reordered.
      iii. For example, the original domain original chroma samples of a video unit may be reordered.
      iv. For example, the residues may be generated by subtracting the prediction from reordered original samples.
   h. Prediction samples of a video unit may be reordered.
      i. For example, the reordering process for prediction samples may be performed right after the motion compensation process.
      ii. For example, sign prediction may be applied based on the reordered prediction samples of the video unit.

### General Aspects

3. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
4. Whether to and/or how to apply the disclosed methods above may be signalled at PB/TB/CB/PU/TU/CU/VPDU/CTU/CTU row/slice/tile/sub-picture/other kinds of region contain more than one sample or pixel.
5. Whether to and/or how to apply the disclosed methods above may be dependent on coded information, such as block size, colour format, single/dual tree partitioning, colour component, slice/picture type.

### 2.2.3 on Sample Reordering-Sample Reordering, Signalling and Storage

The detailed embodiments below should be considered as examples to explain general concepts. These embodiments should not be interpreted in a narrow way. Furthermore, these embodiments can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

It is noted that the terminologies mentioned below are not limited to the specific ones defined in existing standards. Any variance of the coding tool is also applicable.
1. About the signalling of sample reordering (e.g., the 1st and related issues), the following methods are proposed:
   a. For example, at least one new syntax elements (e.g., flag, index, variable, parameter, etc) may be signalled to specify the usage of sample reordering for a video unit.
      a. For example, at least one new syntax elements (e.g., a flag) may be further signalled to specify the usage of sample reordering, given that a certain prediction method is used to a video unit.
      b. For example, a first new syntax element (e.g., a flag) may be further signalled, specifying the usage of sample reordering for an intra template matching coded video unit, given that the intra template matching usage flag specifies the video unit is coded by intra template matching.
      c. For example, a first new syntax element (e.g., a flag) may be further signalled, specifying the usage of sample reordering for an IBC amvp coded video unit, given that the IBC amvp flag specifies the video unit is coded by IBC amvp.
      d. For example, a first new syntax element (e.g., a flag) may be further signalled, specifying the usage of sample reordering for an IBC merge coded video unit, given that the IBC merge flag specifies the video unit is coded by IBC merge.
   b. Furthermore, for example, if the first new syntax element specifies the sample reordering is used to the certain prediction method coded video unit, then a second new syntax element (e.g., a flag) may be further signalled, specifying which reordering method (such as horizontal flipping or vertical flipping) is used to the video unit.
   c. For example, a single new syntax element (e.g., a parameter, or a variable, or an index) may be signalled to a video unit, instead of multiple cascaded syntax elements, specifying the type of reordering (such as no flipping, horizontal flipping, or vertical flipping) applied to the video unit.
      a. For example, one new syntax element (e.g., an index) may be further signalled, specifying the type of sample reordering for an intra template matching coded video unit, given that the intra template matching usage flag specifies the video unit is coded by intra template matching.
      b. For example, one new syntax element (e.g., an index) may be further signalled, specifying the type of sample reordering for an IBC amvp coded video unit, given that the IBC amvp flag specifies the video unit is coded by IBC amvp.
      c. For example, one new syntax element (e.g., an index) may be further signalled, specifying the type of sample reordering for an IBC merge coded video unit, given that the IBC merge flag specifies the video unit is coded by IBC merge.
      d. Additionally, for example, the new syntax element (e.g., an index) equal to 0 specifies that no sample reordering is used; equal to 1 specifies that sample reordering method A is used; equal to 2 specifies that sample reordering method B is used; and etc.
   d. For example, one or more syntax elements related to sample reordering may be context coded.
      a. For example, the context may be based on neighboring blocks/samples coding information (e.g., such as availability, prediction mode, where or not merge coded, whether or not IBC coded, whether or not apply sample reordering, which sample reordering method is used, and etc.).
   e. Alternatively, for example, instead of signalling whether to do the sample reordering and/or which reordering method is used to a video unit, partial (or all) of these steps may be determined based on pre-defined rules (without signalling).
      a. For example, the pre-defined rules may be based on neighboring blocks/samples coded information.
      b. For example, given that the IBC merge flag specifies the video unit is coded by IBC merge, a procedure may be conducted to determine whether to perform reordering and how to reorder, based on pre-defined rules/procedures without signalling.
         i. Alternatively, for example, given that the first new syntax element specifies the sample reordering is used to the video unit, however, instead of further signalling the reordering method, how to reorder may be determined based on pre-defined rules/procedures (without signalling).
         ii. Alternatively, for example, whether to perform reordering may be implicit determined based on pre-defined rules/procedures, but how to reorder may be signalled.
      c. For example, given that the IBC amvp flag specifies the video unit is coded by IBC amvp, a procedure may be conducted to determine whether to perform reordering and how to reorder, based on pre-defined rules/procedures without signalling.
         i. Alternatively, for example, given that the first new syntax element specifies the sample reordering is used to the video unit, however, instead of further signalling the reordering method, how to reorder may be determined based on pre-defined rules/procedures (without signalling).
         ii. Alternatively, for example, whether to perform reordering may be implicit determined based on pre-defined rules/procedures, but how to reorder may be signalled.
      d. For example, given that the intra template matching flag specifies the video unit is coded by IBC merge, a procedure may be conducted to determine whether to perform reordering and how to reorder, based on pre-defined rules/procedures without signalling.
         i. Alternatively, for example, given that the first new syntax element specifies the sample reordering is used to the video unit, however, instead of further signalling the reordering method, how to reorder may be determined based on pre-defined rules/procedures (without signalling).
         ii. Alternatively, for example, whether to perform reordering may be implicit determined based on pre-defined rules/procedures, but how to reorder may be signalled.
   f. For example, whether to perform reordering and/or how to reorder may be inherited from coded blocks.
      a. For example, it may be inherited from an adjacent spatial neighbor block.
      b. For example, it may be inherited from a non-adjacent spatial neighbor block.
      c. For example, it may be inherited from a history-based motion table (such as a certain HMVP table).
      d. For example, it may be inherited from a temporal motion candidate.
      e. For example, it may be inherited based on an IBC merge candidate list.
      f. For example, it may be inherited based on an IBC amvp candidate list.
      g. For example, it may be inherited based on a generated motion candidate list/table.
      h. For example, the sample reordering inheritance may be allowed in case that a video unit is coded by IBC merge mode.
      i. For example, the sample reordering inheritance may be allowed in case that a video unit is coded by IBC AMVP mode.
      j. For example, the sample reordering inheritance may be allowed in case that a video unit is coded by intra template matching mode.
2. About the storage of sample reordering status (e.g., the 2nd and related issues), the following methods are proposed:
   a. For example, the information of whether and/or how to reorder for a video unit may be stored.
      a. For example, the stored information may be used for future video unit's coding.
      b. For example, the information may be stored in a buffer.
         i. For example, the buffer may be a line buffer, a table, more than one line buffer, picture buffer, compressed picture buffer, temporal buffer, etc.
      c. For example, the information may be stored in a history motion vector table (such as a certain HMVP table).
   b. For example, coding information (e.g., such as whether or not apply sample reordering, which sample reordering method is used, block availability, prediction mode, where or not merge coded, whether or not IBC coded, and etc.) may be stored for the derivation of the context of sample reordering syntax element(s).

### General Aspects

3. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
4. Whether to and/or how to apply the disclosed methods above may be signalled at PB/TB/CB/PU/TU/CU/VPDU/CTU/CTU row/slice/tile/sub-picture/other kinds of region contain more than one sample or pixel.
5. Whether to and/or how to apply the disclosed methods above may be dependent on coded information, such as block size, colour format, single/dual tree partitioning, colour component, slice/picture type.

### 2.2.4 on Sample Reordering-Motion List Generation, Implicit Derivation, and how to Reorder

The detailed embodiments below should be considered as examples to explain general concepts. These embodiments should not be interpreted in a narrow way. Furthermore, these embodiments can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

It is noted that the terminologies mentioned below are not limited to the specific ones defined in existing standards. Any variance of the coding tool is also applicable.
1. About the motion candidate list generation for sample reordering (e.g., the 1st and related issues), the following methods are proposed:
   b. For example, IBC merge motion candidate list may be used for both regular IBC merge mode and sample reordering based IBC merge mode.
   c. For example, IBC amvp motion predictor candidate list may be used for both regular IBC amvp mode and sample reordering based IBC amvp mode.
   d. For example, a new motion (predictor) candidate list may be generated for a target video unit coded with sample reordering.
      a. For example, the new candidate list may only consider motion candidates with same reordering method as the reordering method of the target video unit.
      b. For example, the new candidate list may only consider motion candidates coded with sample reordering (but no matter the type of sample reordering method).
      c. Alternatively, the new candidate list may be generated without considering the sample reordering method of each motion candidate.
      d. For example, non-adjacent motion candidates may be inserted to the new candidate list.
         i. For example, non-adjacent candidates with sample reordering (but no matter the type of sample reordering method) may be inserted.
         ii. For example, non-adjacent candidates with same reordering method as the reordering method of the target video unit may be inserted.
         iii. For example, non-adjacent candidates may be inserted no matter the sample reordering method is used to the candidate or not.
      e. For example, new motion candidates may be generated according to a certain rule and inserted to the new candidate list.
         i. For example, the rule may be based on averaging process.
         ii. For example, the rule may be based on clipping process.
         iii. For example, the rule may be based on scaling process.
   e. For example, the motion (predictor) candidate list generation for a target video unit may be dependent on the reordering method.
      a. For example, the reordering method associated with each motion candidate (from spatial or temporal or history tables) may be inserted to the list, no matter the target video unit is to be coded with sample reordering or not.
      b. For example, if the target video unit is to be coded with sample reordering, only those motion candidates (from spatial or temporal or history tables) who coded with same reordering method as the reordering method of the target video unit are inserted to the list.
      c. For example, if the target video unit is to be coded with sample reordering, only those motion candidates (from spatial or temporal or history tables) who coded with sample reordering (but no matter the type of sample reordering method) are inserted to the list.
      d. For example, if the target video unit is to be coded WITHOUT sample reordering, those motion candidates (from spatial or temporal or history tables) who coded with same reordering method may not be inserted to the list.
      e. Alternatively, the motion list generation for a video unit may not be dependent on the reordering method associated with each motion candidate.
   f. For example, the Adaptive Reordering of Merge Candidates (ARMC) of a video unit may be dependent on the reordering method.
      a. For example, if the target video unit is to be coded with sample reordering, the motion candidates who coded with same reordering method as the reordering method of the target video unit may be put prior to those motion candidates who coded with different reordering method.
      b. For example, if the target video unit is to be coded with sample reordering, the motion candidates who coded with sample reordering (but no matter the type of sample reordering method) may be put prior to those motion candidates who coded with different reordering method.
      c. For example, if the target video unit is to be coded WITHOUT sample reordering, the motion candidates who coded without reordering method may be put prior to those motion candidates who coded with reordering method.
      d. Alternatively, the ARMC may be applied to the video unit, no matter the reordering method associated with each motion candidate.
2. About the implicit determination of sample reordering (e.g., the 2nd and related issues), the following methods are proposed:
   a. Whether or not reordering the reconstruction/original/prediction samples of a video unit may be implicitly derived from coded information at both encoder and decoder.
      a. The implicit derivation may be based on costs/errors/differences calculated from coded information.
         i. For example, costs/errors/differences may be calculated based on template matching.
         ii. For example, the template matching may be conducted by comparing samples in a first template and a second template.
         1. For example, the first template is constructed by a group of pre-defined samples neighboring to current video unit, while the second template is constructed by a group of corresponding samples neighboring to a reference video unit.
         2. For example, the cost/error may refer to the accumulated sum of differences between samples in the first template and corresponding samples in the second template.
         a. For example, the difference may be based on luma sample value.
         3. For example, the sample may refer to reconstruction sample, or a variant based on reconstruction sample.
         4. For example, the sample may refer to prediction sample, or a variant based on prediction sample.
      b. For example, a first cost may be calculated without reordering (denoted by Cost0), a second cost may be calculated with reordering (denoted by Cost1). Eventually, the minimum cost value among {Cost0, Cost1} is identified and the corresponding coding method (without reorder, or, reorder) is determined as the final coding method of the video unit.
      c. Alternatively, whether reordering the reconstruction/original/prediction samples of a video unit may be signalled in the bitstream.
         i. For example, it may be signalled by a syntax element (e.g., flag).
   b. Which reordering method is used to reorder the reconstruction/original/prediction samples may be implicitly derived from coded information at both encoder and decoder.
      a. For example, whether horizontal flipping or vertical flipping.
      b. The implicit derivation may be based on costs/errors/differences calculated from coded information.
         i. For example, costs/errors/differences may be calculated based on template matching.
         ii. For example, the template matching may be conducted by comparing samples in a first template and a second template.
         1. For example, the first template is constructed by a group of pre-defined samples neighboring to current video unit, while the second template is constructed by a group of corresponding samples neighboring to a reference video unit.
         2. For example, the cost/error may refer to the accumulated sum of differences between samples in the first template and corresponding samples in the second template.
         a. For example, the difference may be based on luma sample value.
         3. For example, the sample may refer to reconstruction sample, or a variant based on reconstruction sample.
         4. For example, the sample may refer to prediction sample, or a variant based on prediction sample.
         iii. For example, a first cost may be calculated without reordering method A (denoted by Cost0), a second cost may be calculated with reordering method B (denoted by Cost1). Eventually, the minimum cost value among {Cost0, Cost1} is identified and the corresponding coding method (reorder method A, reorder method B) is determined as the final coding method of the video unit.
      c. Alternatively, which reordering method is used to reorder the reconstruction/original/prediction samples of a video unit may be signalled in the bitstream.
         i. For example, it may be signalled by a syntax element (e.g., flag, or an index, or a parameter, or a variable).
   c. Whether or not AND which reordering method is used to reorder the reconstruction/original/prediction samples of a video unit may be implicitly derived from coded information at both encoder and decoder.
      a. For example, a first cost may be calculated without reordering (denoted by Cost0), a second cost may be calculated with reordering method A (denoted by Cost1); a third cost may be calculated with reordering method B (denoted by Cost2). Eventually, the minimum cost value among {Cost0, Cost1, Cost2} is identified and the corresponding coding method (without reorder, reorder method A, reorder method B) is determined as the final coding method of the video unit.
3. About how to reorder samples (e.g., the 3rd and related issues), the following methods are proposed:
   b. A possible sample reordering method may refer to one or more processes as followings:
      a. The reordering process may be applied based on video units.
         i. For example, the reordering process may be based on a block/CU/PU/TU.
         ii. For example, the reordering process may not be based on a tile/slice/picture.
      b. Samples of a video unit may be transformed according to a M-parameter model (such as M=2 or 4 or 6 or 8).
      c. Samples of a video unit may be reordered.
      d. Samples of a video unit may be rotated.
      e. Samples of a video unit may be transformed according to an affine model.
      f. Samples of a video unit may be transformed according to a linear model.
      g. Samples of a video unit may be transformed according to a projection model.
      h. Samples of a video unit may be flipped along the horizontal direction.
      i. Samples of a video unit may be flipped along the vertical direction.

### General Aspects

4. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
5. Whether to and/or how to apply the disclosed methods above may be signalled at PB/TB/CB/PU/TU/CU/VPDU/CTU/CTU row/slice/tile/sub-picture/other kinds of region contain more than one sample or pixel.
6. Whether to and/or how to apply the disclosed methods above may be dependent on coded information, such as block size, colour format, single/dual tree partitioning, colour component, slice/picture type.

### 2.2.5 on Motion Constraint, AMVR Signalling, Template Matching, and Sample Reordering

The detailed embodiments below should be considered as examples to explain general concepts. These embodiments should not be interpreted in a narrow way. Furthermore, these embodiments can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

It is noted that the terminologies mentioned below are not limited to the specific ones defined in existing standards. Any variance of the coding tool is also applicable.
1. About the motion constraints for coding tools (e.g., the 1st problem and related issues), the following methods are proposed:
   a. Motion vector of a video unit coded with a certain prediction method may be constrained by a certain rule.
      a. The motion vector may refer to one or more items as followings:
         i. motion vector difference
         ii. motion vector
         iii. motion vector predictor
   b. The prediction method may refer to one or more items as followings:
      i. IBC AMVP mode
      ii. IBC merge mode
      iii. IBC merge mode with template matching
      iv. Intra template matching
      v. Sample reordering based IBC AMVP mode
      vi. Sample reordering based IBC merge mode
      vii. Sample reordering based IBC merge mode with template matching
      viii. Sample reordering based intra template matching
   c. The rule may refer to one or more items as followings:
      i. The horizontal component of motion vectors may be required to be equal to zero.
      ii. The vertical component of motion vectors may be required to be equal to zero.
   b. For example, given that a video unit is coded with IBC AMVP mode, the horizontal component of motion vectors may be required to be equal to zero.
      a. Alternatively, given that a video unit is coded with IBC AMVP mode, the vertical component of motion vectors may be required to be equal to zero.
      b. Furthermore, the IBC AMVP mode in the disclosed bullet may be replaced by IBC merge mode.
      c. Furthermore, the IBC AMVP mode in the disclosed bullet may be replaced by IBC with template matching mode.
         i. In one example, the template matching may be required to be searched along one direction (either horizontal or vertical).
      d. Furthermore, the IBC AMVP mode in the disclosed bullet may be replaced by intra template matching mode.
         i. In one example, the template matching may be required to be searched along one direction (either horizontal or vertical).
   c. For example, given that a video unit is coded with sample reordering based IBC AMVP mode (such as samples are flipping horizontally), the vertical component of motion vectors may be treated/constrained/required to be equal to zero.
      a. For example, given that a video unit is coded with sample reordering based IBC AMVP mode (such as samples are flipping vertically), the horizontal component of motion vectors may be treated/constrained/required to be equal to zero.
      b. Furthermore, the IBC AMVP mode in the disclosed bullet may be replaced by IBC merge mode.
      c. Furthermore, the IBC AMVP mode in the disclosed bullet may be replaced by IBC with template matching mode.
         i. In one example, the template matching may be required to be searched along horizontal direction (vertical component of motion vectors equal to 0) for horizontal flip.
         ii. In one example, the template matching may be required to be searched along vertical direction (horizontal component of motion vectors equal to 0) for vertical flip.
      d. Furthermore, the IBC AMVP mode in the disclosed bullet may be replaced by intra template matching mode.
   d. For example, if a certain component of a motion vector (such as MVx or MVy) of a video unit is treated/constrained/required to be equal to zero,
      a. The corresponding component of the motion vector difference (such as MVDx or MVDy) of the video unit may be treated/constrained/required to be equal to zero.
      b. The corresponding component of the motion vector predictor (such as MVPx or MVPy) of the video unit may be treated/constrained/required to be equal to zero.
   e. For example, if a certain component of a motion vector difference (such as MVDx or MVDy) of a video unit is treated/constrained/required to be equal to zero,
      a. The corresponding component of a motion vector difference may be not signalled but inferred to be equal to zero.
   f. For example, the signaling of motion vector difference (MVD) for a certain video unit may be dependent on the motion constraint applied to the video unit.
      a. For example, the sign of MVDx may be not signalled, given that MVDx of the video unit treated/constrained/required to be equal to zero.
      b. For example, the sign of MVDy may be not signalled, given that MVDy of the video unit treated/constrained/required to be equal to zero.
   g. For example, if a first component of a motion vector is treated/constrained/required to be equal to zero, the first component of the corresponding MVD/MVP is treated/constrained/required to be equal to zero.
   h. “zero” in the above bullets may be replaced by any other fixed or derived or signaled value.
2. About the AMVR signalling based on the motion constraint (e.g., the 2nd problem and related issues), the following methods are proposed:
   a. For example, the signaling of the resolution of the motion vector difference (e.g., amvr_precision_idx of AMVR) for a certain video unit may be dependent on the motion constraint applied to the video unit.
      a. For example, the video unit may be coded with a kind of AMVP mode.
      b. For example, the video unit may be coded with IBC AMVP.
      c. For example, the video unit may be coded with sample reordering based IBC AMVP.
      d. For example, the video unit may be coded with sample reordering based AMVP mode.
      e. For example, the signalling/presence of the resolution of the motion vector difference (e.g., amvr_precision_idx) may be decoupled from MVDx. For example, the signaling may be only dependent on whether the value of MVDy is equal to zero (instead of checking both MVDx and MVDy), given that MVDx of the video unit treated/constrained/required to be equal to zero.
      f. For example, the signalling/presence of the resolution of the motion vector difference (e.g., amvr_precision_idx) may be decoupled from MVDy. For example, the signaling may be only dependent on whether the value of MVDx is equal to zero (instead of checking both MVDx and MVDy), given that MVDy of the video unit treated/constrained/required to be equal to zero.
      g. For example, if the resolution of the motion vector difference (e.g., amvr_precision_idx) is not signalled for such video unit, it may be inferred to be equal to a certain value (such as 0) indicating a default resolution is used.
         i. For example, the default resolution may be 1-pel precision, in case the video unit is coded based on IBC AMVP mode.
         ii. For example, the default resolution may be 1-pel precision, in case the video unit is coded based on sample reordering based IBC AMVP mode.
   b. For example, the signaling of amvr_precision_idx for IBC AMVP coded block may be changed as follows (taking the syntax structure in the VVC spec as an example), wherein cu_ibc_reorder_type indicates whether and how samples in the IBC AMVP coded block are reordered.

| | |
|---|---|
| ... | |
| else if( CuPredMode[ chType ][ x0 ][ y0 ] = = MODE_IBC ) { | |
| mvd_coding( x0, y0, 0, 0 ) | |
| if( MaxNumIbcMergeCand > 1 ) | |
| mvp_l0_flag[ x0 ][ y0 ] | ae(v) |
| if( sps_amvr_enabled_flag | |
| ( MvdL0[ x0 ][ y0 ][ 0 ] != 0 \|\| | |
| MvdL0[ x0 ][ y0 ][ 1 ] != 0 && | |
| cu_ibc_reorder_type == NO_FLIP) \|\| | |
| (MvdL0[ x0 ][ y0 ][ 1 ] != 0 && | |
| cu_ibc_reorder_type == FLIP_HOR ) \|\| | |
| ( MvdL0[ x0 ][ y0 ][ 0 ] != 0 && | |
| cu_ibc_reorder_type == FLIP_VER ) | |
| ) | |
| amvr_precision_idx[ x0 ][ y0 ] | ae(v) |
| } else { | |
| ... | |

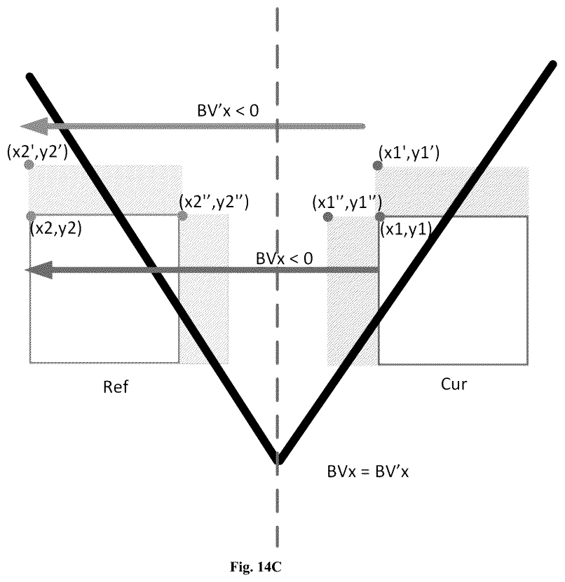

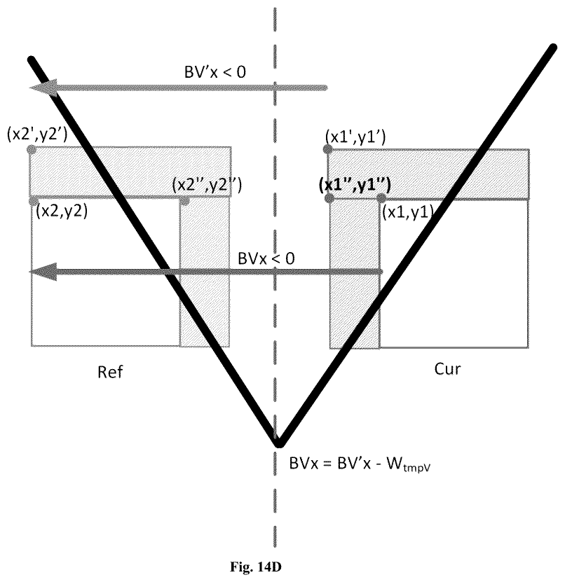

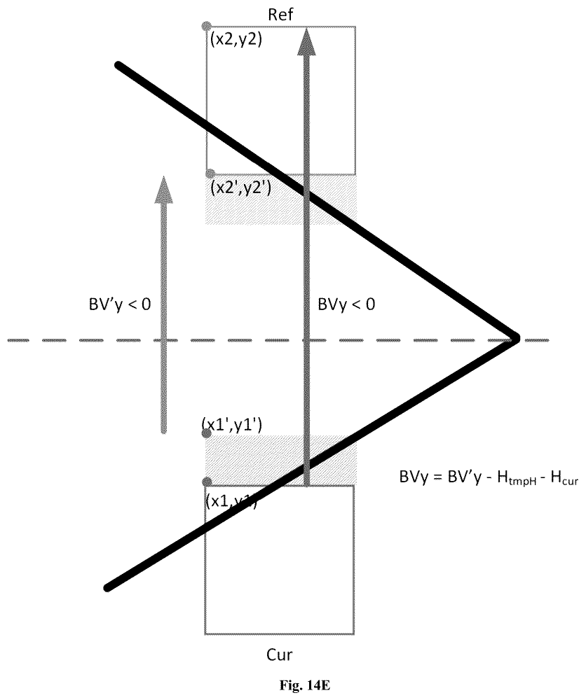

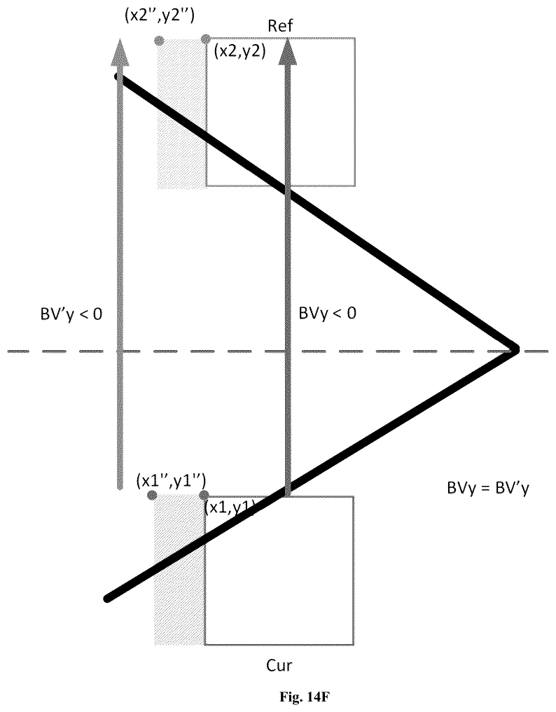

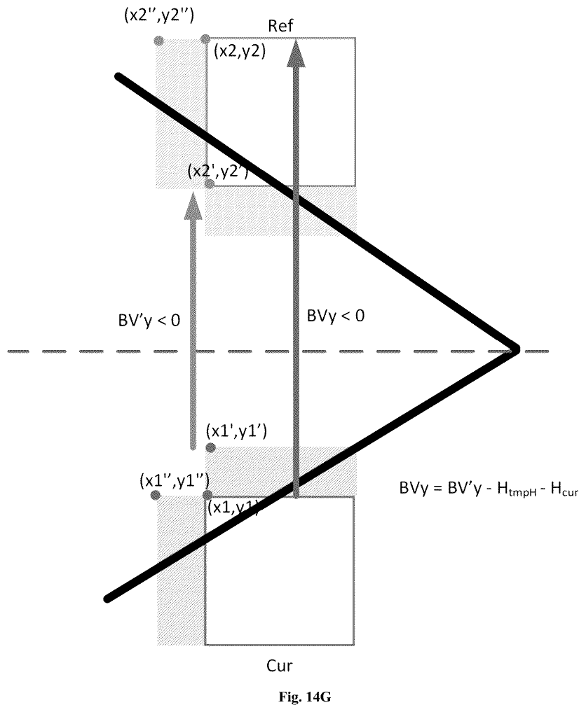

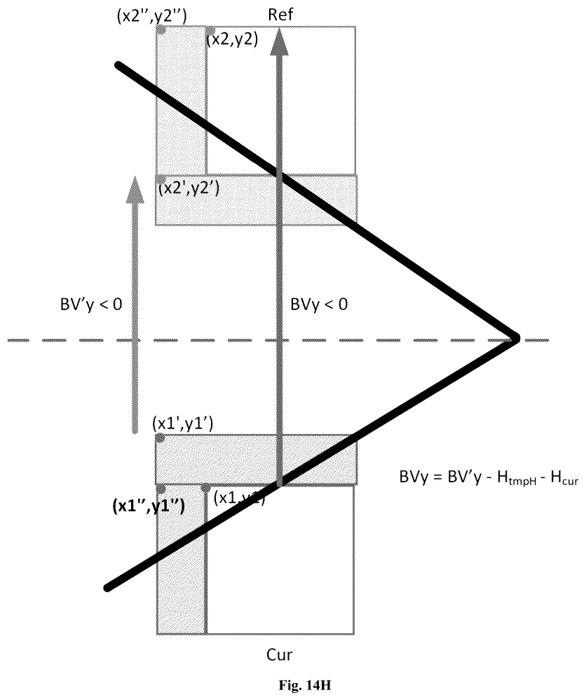

3. About the template matching (e.g., intra TM, IBC with TM) modification in case of enabling sample reordering (e.g., the 3rd problem and related issues), the following methods are proposed:
   Suppose a first template is used for a first video unit coded with TM with sample reordering, and a second template is used for a second video unit coded with TM without sample reordering:
   a. For example, the locations of samples that comprise the template may be dependent on the sample reordering method used to a video unit.
      a. For example, the sample locations of the first template and the second template may be different.
      b. For example, the second template may be constructed from samples above and left to the video unit.
      c. For example, the first template may be constructed from samples above OR left to the video unit.
         i. For example, if the first video unit is coded with horizontal flipping, then the first template may be constructed from samples above to the video unit.
         ii. For example, if the first video unit is coded with vertical flipping, then the first template may be constructed from samples left to the video unit.
      d. Alternatively, the sample locations of the first template and the second template may be same.
   b. For example, the number of samples that comprise the template may be dependent on the sample reordering method used to a video unit.
      a. For example, the number of rows and/or columns of the first template and the second template may be different.
      b. For example, the second template may be constructed from M1 rows of samples above and N1 columns of samples left to the video unit, while the first template may be constructed from M2 rows of samples above and/or N2 columns of samples left to the video unit. The following rules may conform:
         i. M1!=M2
         ii. N1!=N2
      c. Alternatively, the number of rows and/or columns of the first template and the second template may be same.
4. About sample reordering based intra/IBC template matching (e.g., the 4th problem and related issues), the following methods are proposed:
   a. How to derive the reference template of a sample reordering coded block may be dependent on coding information.
      a. For example, it may be dependent on the sample reordering type and/or the template shape to be used to the current block.
   b. The derivation of motion vector (block vector) of a sample reordering coded block may be dependent on coding information.
      a. For example, it may be dependent on the sample reordering type and/or the template shape to be used to the current block.
      b. For example, it may be dependent on the dimensions (such as width and/or height) of the current block.
      c. For example, it may be dependent on the dimensions (such as width and/or height) of the template (or partial template).
      d. For example, it may be dependent on the coordinates of positions of the current block or the template (such as a center sample location or the top-left sample location).
         i. For example, the template may be current template and/or reference template.
   c. Eight examples of sample reordering based template matching are shown in FIG. 14A to FIG. 14H, wherein the dashed line denotes the flipping is performed across that dashed line (i.e., horizontal dash line indicates vertical flip which means flip upside down, vertical dashed line indicates horizontal flip which means flip left right), blue rectangles denotes current block and current template, orange rectangles denotes reference block and reference template, BV′x and BV′y denote the horizontal and vertical displacement between the current template and the reference template, respectively, BVx and BVy denote the horizontal and vertical displacement between the current block and the reference block, respectively, (W_{cur}, H_{cur}) denotes the width and height of current block, (W_{tmpH}, H_{tmpH}) denotes the width and height of the horizontal template along the block width direction, (W_{tmpV}, H_{tmpV}) denotes the width and height of the vertical template along the block height direction, (x1, y1) and (x2, y2) represent the coordinates of top-left sample of the current block and the reference block, respectively, (x1′, y1′) and (x2′, y2′) represent the coordinates of top-left sample of the current horizontal template and the reference horizontal template, respectively, (x1″, y1″) and (x2″, y2″) represent the coordinates of top-left sample of the current vertical template and the reference vertical template, respectively
      a. For example, in case of horizontal template and horizontal flip (i.e., FIG. 14A),
         i. In one example, both the current template and reference template may comprises neighboring samples above to the current block.
         ii. In one example, the relative location of (current block, current template) and the relative location of (reference block, reference template) may be same.
         1. In one example, x1−x1′=x2−x2′, and y1−y1′=y2−y2′
         2. In one example, x1−x1′=0, and y1−y1′=H_{tmpH}
         iii. In one example, either the samples in the current template or the samples in the reference template may be flipped.
         iv. In one example, the samples in the current template may be flipped according to the flip type being checked (e.g., horizontal flip).
         v. In one example, the samples in the reference template may be flipped according to the flip type being checked (e.g., horizontal flip).
         vi. In one example, BVx=BV′x
         vii. In one example, x1′−x2′=x1−x2
      b. For example, in case of vertical template and horizontal flip (i.e., FIG. 14B),
         i. In one example, the current template may comprises neighboring samples left to the current block, and the reference template may comprises neighboring samples right to the current block.
         ii. In one example, the relative location of (current block, current template) and the relative location of (reference block, reference template) may be different
         1. In one example, x1−x1″!=x2−x2″, and y1−y1″=y2−y2″
         2. In one example, x1−x1″=W_{tmpV}, and y1−y1″=0
         3. In one example, x2−x2″=−W_{cur}, and y2−y2″=0
         iii. In one example, either the samples in the current template or the samples in the reference template may be flipped.
         iv. In one example, the samples in the current template may be flipped according to the flip type being checked (e.g., horizontal flip).
         v. In one example, the samples in the reference template may be flipped according to the flip type being checked (e.g., horizontal flip).
         vi. In one example, BVx=BV′x−W_{cur}−W_{tmpV}
         vii. In one example, x2″−x1″−W_{cur}−W_{tmpV}=x2−x1
      c. For example, in case of horizontal-vertical template (wherein W_{tmpH}=W_{cur}) and horizontal flip (i.e., FIG. 14C),
         i. In one example, the current template may comprises neighboring samples above and left to the current block, and the reference template may comprises neighboring samples above and right to the current block.
         ii. In one example, the relative location of (current block, current horizontal template) and the relative location of (reference block, reference horizontal template) may be same.
         1. In one example, x1−x1′=x2−x2′, and y1−y1′=y2−y2′
         2. In one example, x1−x1′=0, and y1−y1′=H_{tmpH}
         iii. In one example, the relative location of (current block, current vertical template) and the relative location of (reference block, reference vertical template) may be not same.
         1. In one example, x1−x1″!=x2−x2″, and y1−y1″=y2−y2″
         2. In one example, x1−x1″=W_{tmpV}, and y1−y1″=0
         3. In one example, x2−x2″=−W_{cur}, and y2−y2″=0
         iv. In one example, either the samples in the current horizontal template or the samples in the reference horizontal template may be flipped.
         1. Furthermore, either the samples in the current vertical template or the samples in the reference vertical template may be flipped.
         v. In one example, the samples in the current horizontal and vertical template may be flipped according to the flip type being checked (e.g., horizontal flip).
         vi. In one example, the samples in the reference horizontal and vertical template may be flipped according to the flip type being checked (e.g., horizontal flip).
         vii. In one example, BVx=BV′x
         viii. In one example, x1′-×2′=×1-×2
      d. For example, in case of horizontal-vertical template (wherein W_{tmpH}=W_{cur}+W_{tmpV}) and horizontal flip (i.e., FIG. 14D),
         i. In one example, the current template may comprises neighboring samples above and left to the current block, and the reference template may comprises neighboring samples above and right to the current block.
         ii. In one example, the relative location of (current block, current horizontal template) and the relative location of (reference block, reference horizontal template) may be not same.
         1. In one example, x1−x1′!=x2−x2′, and y1−y1′=y2−y2′
         2. In one example, x1−x1′=W_{tmpV}, and y1−y1′=H_{tmpH}
         3. In one example, x2−x2′=0, and y2−y2′=H_{tmpH}
         iii. In one example, the relative location of (current block, current vertical template) and the relative location of (reference block, reference vertical template) may be not same.
         1. In one example, x1−x1″!=x2−x2″, and y1−y1″=y2−y2″
         2. In one example, x1−x1″=W_{tmpV}, and y1−y1″=0
         3. In one example, x2−x2″=−W_{cur}, and y2−y2″=0
         iv. In one example, either the samples in the current horizontal template or the samples in the reference horizontal template may be flipped.
         1. Furthermore, either the samples in the current vertical template or the samples in the reference vertical template may be flipped.
         v. In one example, the samples in the current horizontal and vertical template may be flipped according to the flip type being checked (e.g., horizontal flip).
         vi. In one example, the samples in the reference horizontal and vertical template may be flipped according to the flip type being checked (e.g., horizontal flip).
         vii. In one example, BVx=BV′x−W_{tmpV}
         viii. In one example, x2′−x1′−W_{tmpV}=x2−x1
      e. For example, in case of horizontal template and vertical flip (i.e., FIG. 14E),
         i. In one example, the current template template may comprises neighboring samples above to the current block, and the reference template may comprises neighboring samples below to the current block.
         ii. In one example, the relative location of (current block, current template) and the relative location of (reference block, reference template) may be not same.
         1. In one example, x1−x1′=x2−x2′, and y1−y1′!=y2−y2′
         2. In one example, x1−x1′=0, and y1−y1′=H_{tmpH}
         3. In one example, x2−x2′=0, and y2−y2′=−H_{cur}
         iii. In one example, either the samples in the current template or the samples in the reference template may be flipped.
         iv. In one example, the samples in the current template may be flipped according to the flip type being checked (e.g., vertical flip).
         v. In one example, the samples in the reference template may be flipped according to the flip type being checked (e.g., vertical flip).
         vi. In one example, BVy=BV′y-H_{tmpH}−H_{cur}
         vii. In one example, y2′−y1′−H_{tmpH}−H_{cur}=y2−y1
      f. For example, in case of vertical template and vertical flip (i.e., FIG. 14F),
         i. In one example, both the current template and the reference template may comprises neighboring samples left to the current block.
         ii. In one example, the relative location of (current block, current template) and the relative location of (reference block, reference template) may be same
         1. In one example, x1−x1″=x2−x2″, and y1−y1″=y2−y2″
         2. In one example, x1−x1″=W_{tmpV}, and y1−y1″=0
         iii. In one example, either the samples in the current template or the samples in the reference template may be flipped.
         iv. In one example, the samples in the current template may be flipped according to the flip type being checked (e.g., vertical flip).
         v. In one example, the samples in the reference template may be flipped according to the flip type being checked (e.g., vertical flip).
         vi. In one example, BVy=BV′y
         vii. In one example, y1″−y2″=y1−y2
      g. For example, in case of horizontal-vertical template (wherein W_{tmpH}=W_{cur}) and vertical flip (i.e., FIG. 14G),
         i. In one example, the current template may comprises neighboring samples above and left to the current block, and the reference template may comprises neighboring samples left and below to the current block.
         ii. In one example, the relative location of (current block, current horizontal template) and the relative location of (reference block, reference horizontal template) may be not same.
         1. In one example, x1−x1′=x2−x2′, and y1−y1′!=y2−y2′
         2. In one example, x1−x1′=0, and y1−y1′=H_{tmpH}
         3. In one example, x2−x2′=0, and y2−y2′=−H_{cur}
         iii. In one example, the relative location of (current block, current vertical template) and the relative location of (reference block, reference vertical template) may be same.
         1. In one example, x1−x1″=x2−x2″, and y1−y1″=y2−y2″
         2. In one example, x1−x1″=W_{tmpV}, and y1−y1″=0
         iv. In one example, either the samples in the current horizontal template or the samples in the reference horizontal template may be flipped.
         1. Furthermore, either the samples in the current vertical template or the samples in the reference vertical template may be flipped.
         v. In one example, the samples in the current horizontal and vertical template may be flipped according to the flip type being checked (e.g., vertical flip).
         vi. In one example, the samples in the reference horizontal and vertical template may be flipped according to the flip type being checked (e.g., vertical flip).
         vii. In one example, BVy=BV′y−H_{tmpH}−H_{cur}
         viii. In one example, y2′−y1′−H_{tmpH}−H_{cur}=y2−y1
      h. For example, in case of horizontal-vertical template (wherein W_{tmpH}=W_{cur}+W_{tmpV}) and vertical flip (i.e., FIG. 14H),
         i. In one example, the current template may comprises neighboring samples above and left to the current block, and the reference template may comprises neighboring samples left and below to the current block.
         ii. In one example, the relative location of (current block, current horizontal template) and the relative location of (reference block, reference horizontal template) may be not same.
         1. In one example, x1−x1′=x2−x2′, and y1−y1′!=y2−y2′
         2. In one example, x1−x1′=W_{tmpV}, and y1−y1′=H_{tmpH}
         3. In one example, x2−x2′=W_{tmpV}, and y2−y2′=−H_{cur}
         iii. In one example, the relative location of (current block, current vertical template) and the relative location of (reference block, reference vertical template) may be same.
         1. In one example, x1−x1″=x2−x2″, and y1−y1″=y2−y2″
         2. In one example, x1−x1″=W_{tmpV}, and y1−y1″=0
         iv. In one example, either the samples in the current horizontal template or the samples in the reference horizontal template may be flipped.
         1. Furthermore, either the samples in the current vertical template or the samples in the reference vertical template may be flipped.
         v. In one example, the samples in the current horizontal and vertical template may be flipped according to the flip type being checked (e.g., vertical flip).
         vi. In one example, the samples in the reference horizontal and vertical template may be flipped according to the flip type being checked (e.g., vertical flip).
         vii. In one example, BVy=BV′y−H_{tmpH}−H_{cur}
         viii. In one example, y2′−y1′−H_{tmpH}−H_{cur}=y2−y1
5. About the motion search with template matching when sampling reordering method is applied, (e.g., the 5th problem and related issues), the following methods are proposed:
   a. In one example, for a sample reordering method (such as vertical flip or horizontal flip) samples in the template around the current block may be reordered before being compared with samples (which are not reordered) in the template around the reference block to get a cost.
   b. In one example, for a sample reordering method (such as vertical flip or horizontal flip) samples in the template around the reference block may be reordered before being compared with samples (which are not reordered) in the template around the current block to get a cost.
   c. In one example, for a sample reordering method (such as vertical flip or horizontal flip) samples in both the template around the reference block and the template around the current block may be reordered before being compared to get a cost.
6. About how to determine the sampling reordering method (such as no flip, vertical flip or horizontal flip) for a template matching (such as intra template matching, and/or IBC mode with template matching) coded block (e.g., the 6th problem and related issues), the following methods are proposed:
   a. In one example, the sampling reordering method may depend on at least one syntax element signaled from the encoder to the decoder.
      i. In one example, the syntax element may indicate whether to and/or how to reorder samples for a template matching coded block (such as intra template matching, and/or IBC mode with template matching, etc.).
      ii. The syntax element may be coded with the same manner as that used to indicate whether to and/or how to reorder samples for a certain prediction method (such as IBC) coded block.
   b. In one example, the sampling reordering method may be derived based on at least one template cost.
      i. In one example, motion search with template matching with different sampling reordering methods may be applied for a block, to derive the minimum costs for different sampling reordering methods.
      ii. In one example, the sampling reordering method with the smallest template cost may be derived as the determined sampling reordering method.

### General Aspects

7. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
8. Whether to and/or how to apply the disclosed methods above may be signalled at PB/TB/CB/PU/TU/CU/VPDU/CTU/CTU row/slice/tile/sub-picture/other kinds of region contain more than one sample or pixel.
9. Whether to and/or how to apply the disclosed methods above may be dependent on coded information, such as block size, colour format, single/dual tree partitioning, colour component, slice/picture type.

### 2.2.6 on Interaction of RRIBC and IBC-TM_v0

The detailed embodiments below should be considered as examples to explain general concepts. These embodiments should not be interpreted in a narrow way. Furthermore, these embodiments can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

It is noted that the terminologies mentioned below are not limited to the specific ones defined in existing standards.

Any variance of the coding tool is also applicable.
1. About the interaction between RRIBC and IBC-TM such as how to build IBC-TM-MERGE list when a neighbor candidate is coded as RRIBC (e.g., the 1st problem and related issues), the following methods are proposed:
   a. For example, an IBC-TM-MERGE candidate may inherit motion from a RRIBC coded neighbor block.
      a. In one example, the motion may be directly inherited.
      b. In one example, the motion may be firstly adjusted (e.g., adding a motion shift to it) then inherited.
      c. Alternatively, an IBC-TM-MERGE candidate may NOT inherit motion from a RRIBC coded neighbor block.
   b. For example, an IBC-TM-MERGE candidate may NOT inherit the flip type from a RRIBC coded neighbor block.
      a. In one example, the flip type of the IBC-TM-MERGE candidate may always set equal to NO_FLIP, no matter whether or not the motion of such IBC-TM merge candidate is inherited from a RRIBC coded neighbor block.
   c. Alternatively, an IBC-TM-MERGE candidate may inherit flip type from a RRIBC coded neighbor block.
      a. In one example, the flip type of such IBC-TM-MERGE candidate is set equal to the flip type of the RRIBC coded neighbor block.
   d. For example, an IBC-TM-MERGE candidate may inherit motion from a RRIBC coded neighbor block, but never inherit the flip type from the RRIBC coded neighbor block.
      a. In one example, the motion may be directly inherited.
      b. In one example, the motion may be firstly adjusted (e.g., adding a motion shift to it) then inherited.
      c. In one example, the flip type of an IBC-TM-MERGE candidate may always set equal to NO_FLIP.
   e. For example, an IBC-TM-MERGE candidate may be prohibited to be derived based on a RRIBC coded neighbor block.
      a. In such case, the motion and flip type of a RRIBC coded neighbor block may be prohibited to be added to an IBC-TM-MERGE candidate.
      b. In such case, never insert a neighbor block's coding information to an IBC-TM-MERGE list, if the neighbor block is coded with RRIBC.
2. About the interaction between RRIBC and IBC-TM such as how to build a RRIBC based IBC-AMVP list when IBC-TM is allowed (e.g., the 2nd problem and related issues), the following methods are proposed:
   a. For example, in case that the current video unit is IBC-AMVP mode with RRIBC (e.g., the flip type of the current video unit is NOT equal to NO_FLIP), an AMVP candidate may NOT be allowed to be refined by template matching (e.g., IBC-TM-AMVP).
   b. For example, in case that the current video unit is IBC-AMVP mode with non-RRIBC (e.g., the flip type of the current video unit is equal to NO_FLIP), an AMVP candidate may be refined by template matching (e.g., IBC-TM AMVP).
   c. For example, the MVD thresholds for the similarity check (e.g., pruning process by comparing the similarity between a potential candidate and another candidate already in the list) during IBC-AMVP list generation, may be different from different video units, according to whether the current video unit is coded by RRIBC, or non-RRIBC.
      a. In one example, assume the MVD threshold for an IBC-AMVP non-RRIBC coded video unit is equal to K1, and the MVD threshold for an IBC-AMVP RRIBC video unit is equal to K2, then, K1 may not be equal to K2.
      b. Additionally, furthermore, K1 may be greater than K2.
      c. Additionally, furthermore, K1 and/or K2 may be pre-defined.
         i. For example, K1 and/or K2 may be equal to a certain number (such as 0 or 1).
         ii. For example, K1 and/or K2 may be dependent on dimensions of the current video unit (such as width/height, number of samples/pixels).
         iii. For example, K1 and/or K2 may be derived based on the same rule used in the similarity check of an existing coding tool in the codec (e.g., IBC-TM-MERGE mode, inter-TM mode, and etc.).
      d. Alternatively, K1 may be equal to K2.
   d. For example, in case that the current video unit is IBC-AMVP mode with RRIBC (e.g., the flip type of the current video unit is NOT equal to NO_FLIP) and an MVP candidate of the current video unit is also coded with RRIBC,
      a. In one example, the motion vector of the MVP candidate may be adjusted first then used for the current video unit.
      b. In one example, only if the flip type of the current video unit and the flip type of the neighbor block which used to derive the MVP candidate are same, the motion adjustment may be performed.
         i. Alternatively, as long as the current video unit and the neighbor block are RRIBC coded, the motion adjustment may be performed.
      c. In one example, the motion adjustment may refer to add a motion shift to the MVP candidate.
      d. In one example, the motion shift may be dependent on the block dimensions and/or locations of the current video unit.
      e. In one example, the motion shift may be dependent on the block dimensions and/or locations of the neighbor block which used to derive the MVP candidate.
   e. For example, in case that the current video unit is IBC-AMVP mode with non-RRIBC (e.g., the flip type of the current video unit is equal to NO_FLIP) and an MVP candidate of the current video unit is coded with RRIBC,
   a. In one example, the motion vector of the MVP candidate may NOT be adjusted.
   b. Alternatively, the motion vector of the MVP candidate may be adjusted.
      i. In one example, as long as the neighbor block is RRIBC coded, the motion adjustment may be used.
   c. In one example, the motion adjustment may refer to add a motion shift to the MVP candidate.
   d. In one example, the motion shift may be dependent on the block dimensions and/or locations of the current video unit.
   e. In one example, the motion shift may be dependent on the block dimensions and/or locations of the neighbor block which used to derive the MVP candidate.

### 3. PROBLEMS

How to handle the interaction between RRIBC and adaptive reordering motion compensation (e.g., ARMC) needs to be considered.
1. How to apply ARMC in case that the prediction list contains RRIBC candidates.
2. Which samples should be used to construct the reference template for RRIBC based ARMC.
3. Whether and how to reorder the samples in the template for RRIBC based ARMC.

In case RRIBC may be extended to template-based methodologies such as IBC-TM MERGE and/or templated based AMVP candidate refinement, and/or intra-TM.
4. The location of current template relative to the current video unit and the location of the reference template relative to the reference video unit may be different.
   a. Furthermore, the samples in the reference template may be filled with sample values inside the reference video unit.
5. The samples in the current template or reference template may be reordered.

### 4. EMBODIMENTS

The detailed embodiments below should be considered as examples to explain general concepts. These embodiments should not be interpreted in a narrow way. Furthermore, these embodiments can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

It is noted that the terminologies mentioned below are not limited to the specific ones defined in existing standards. Any variance of the coding tool is also applicable.

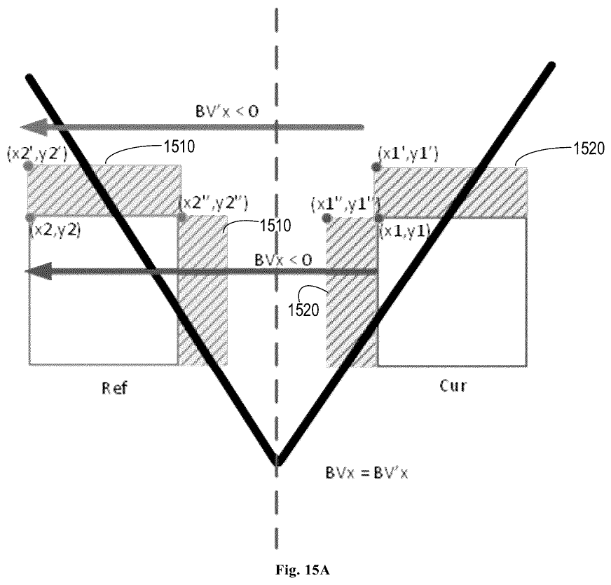

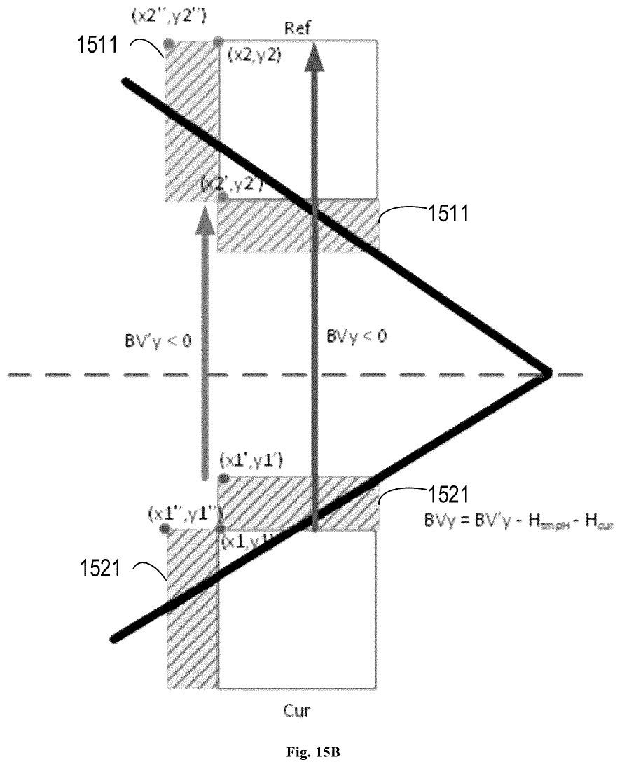

FIG. 15A shows reference template 1510 and current template 1520 for the template cost calculation when the motion candidate is RRIBC coded, where the motion candidate is RRIBC coded with horizontally flip. FIG. 15B shows reference template 1511 and current template 1521 for the template cost calculation when the motion candidate is RRIBC coded, where the motion candidate is RRIBC coded with vertically flip.
4.1 About the interaction between RRIBC and ARMC such as how to apply ARMC in case that the prediction list contains RRIBC candidates (e.g., the 1st problem and related issues), the following methods are proposed:
   a. For example, if a prediction list contains at least one RRIBC coded motion candidate, the ARMC may be used for such prediction list, but using different shape of templates for different motion candidates, based on the RRIBC flip type of the specific motion candidate.
   b. For example, if a prediction list contains at least one RRIBC coded motion candidate, the ARMC may be not used for such prediction list.
   c. For example, if a prediction list contains at least one RRIBC coded motion candidate, the ARMC may be used only for non-RRIBC coded motion candidates.
      a. In one example, assume the motion candidates in the prediction list are separated into different subgroups according to whether RRIBC is used (such as RRIBC subgroup and non-RRIBC subgroup),
         i. For example, for motion candidates in the RRIBC subgroup, the ARMC may NOT be applied.
         ii. For example, for motion candidates in the non-RRIBC subgroup, the ARMC may be applied.
      b. In one example, the order of which subgroup (RRIBC, non-RRIBC) of candidates are put in the first of the final prediction list may be dependent on coding information.
         i. In one example, the ARMC sorted non-RRIBC candidates may be put before the non-ARMC processed RRIBC candidates.
         ii. In one example, the ARMC sorted non-RRIBC candidates may be put after the non-ARMC processed RRIBC candidates.
         iii. In one example, the coding information may refer to the flip type of the first available candidate in the original prediction list (before ARMC processed).
         iv. In one example, if the first available candidate in the original prediction list is RRIBC coded, then the non-ARMC processed RRIBC candidates may be put first.
         v. In one example, if the first available candidate in the original prediction list is non-RRIBC coded, then the ARMC sorted non-RRIBC candidates may be put first.
4.2 About the interaction between RRIBC and ARMC such as which samples should be used to construct reference template for RRIBC based ARMC (e.g., the 2nd problem and related issues), the following methods are proposed:
   a. For example, when perform ARMC to a prediction list which includes at least one RRIBC coded candidate, a second reference template different from a first reference template may be used, wherein “reference template” refers to a template of the reference block.
      a. In one example, the first reference template is constructed from left samples and/or above samples neighboring to the reference block (as shown in FIG. 15A and FIG. 15B).
         i. Furthermore, additionally, the first reference template is used to calculate the template cost of a non-RRIBC coded candidate.
      b. In one example, the second reference template may be constructed from bottom samples neighboring to the reference block.
      c. In one example, the second reference template may be constructed from right samples neighboring to the reference block.
      d. In one example, the second reference template may be used to calculate the template cost of a RRIBC coded candidate.
      e. In one example, whether to use bottom samples or right samples neighboring to the reference block to construct the reference template may be dependent on the flip type of the RRIBC coded candidate.
      f. In one example, whether to use a second reference template or a first reference template may be dependent on the flip type of the candidate.
      g. In one example, as shown in FIG. 15A, a second template is constructed from above and right samples neighboring to the reference block, while a first template is constructed from above and left samples neighboring to the current block.
      h. In one example, as shown in FIG. 15B, a second template is constructed from bottom and left samples neighboring to the reference block, while a first template is constructed from above and left samples neighboring to the current block.
   b. For example, a validation check may be applied to the reference template of RRIBC coded candidate.
      a. In one example, as shown in FIG. 15A, a validation check may be applied to check whether the right part of the reference template is within a valid area.
      b. In one example, as shown in FIG. 15B, a validation check may be applied to check whether the bottom part of the reference template is within a valid area.
      c. In one example, the valid area may be pre-defined by a set of rules related to coding information such as VPDU size, LCU size, tile/picture/slice boundary, tile row, and etc.
      d. In one example, if a sample of the reference template is outside a valid region, another sample within the valid region may be used instead to construct the reference template.
         i. For example, a valid sample nearest to the invalid sample may be used.
         ii. For example, a valid sample inside the reference block (e.g., close to the invalid sample) may be used.
      e. In one example, if at least one sample of the reference template is outside a valid region, the reference template of such candidate may be treated as unavailable.
         i. For example, in such case, ARMC may not be applied to the prediction list.
      f. In one example, as shown in FIG. 15A, if at least one sample of the right part of the reference template is outside a valid area, then at least one sample on the rightmost M columns inside the reference block may be used instead to construct the reference template, wherein M is equal to the width of the right part of the reference template (e.g., M is predefined).
      g. In one example, as shown in FIG. 15B, if at least one sample of the bottom part of the reference template is outside a valid area, then at least one sample on the top N rows inside the reference block may be used instead to construct the reference template, wherein N is equal to the height of the bottom part of the reference template (e.g., N is predefined).
   c. For example, the term “samples” in above aspects may refer to reconstruction samples.
   d. For example, the term “samples” in above aspects may refer to prediction samples.
4.3 About the interaction between RRIBC and ARMC such as whether and how to reorder the samples in the template for RRIBC based ARMC (e.g., the 3rd problem and related issues), the following methods are proposed:
   a. For example, when perform ARMC to a prediction list which includes at least one RRIBC coded candidate, the samples in a reference template may be reordered (i.e., horizontal flip, vertical flip, and etc.).
      a. In one example, the samples in the above part of the reference template may be reordered, and/or the samples in the right part of the reference template may be reordered.
      b. In one example, the samples in the left part of the reference template may be reordered, and/or the samples in the bottom part of the reference template may be reordered.
      c. In one example, whether to reorder samples in the reference template may be dependent on the flip type of the candidate.
      d. In one example, as shown in FIG. 15A, samples in the above part of the reference template which is constructed from above samples neighboring to the reference block, may be horizontally flipped.
      e. In one example, as shown in FIG. 15B, samples in the right part of the reference template which is constructed from right samples neighboring to the reference block, may be horizontally flipped.
         i. Furthermore, additionally, if the width of the right part of the reference template is equal to a certain number (such as 1), then there may be no need to perform horizontally flip.
      f. In one example, as shown in FIG. 15B, samples in the left part of the reference template which is constructed from left samples neighboring to the reference block, may be vertically flipped.
      g. In one example, as shown in FIG. 15B, samples in the bottom part of the reference template which is constructed from bottom samples neighboring to the reference block, may be vertically flipped.
         i. Furthermore, additionally, if the height of the bottom part of the reference template is equal to a certain number (such as 1), then there may be no need to perform vertically flip.
      h. In one example, suppose “temp” denotes the sample buffer of the above/right/left/bottom part of the reference template, (tempW, tempH) denotes the width and height of the above/right/left/bottom part of the reference template, (x,y) denotes the location of the top-left sample of the above/right/left/bottom part of the reference template relative such part of the reference template, “cur” denotes the sample buffer of the current video unit, (curW, curH) denotes the width and height of the current video unit, “curStride” denotes the stride of the sample buffer of current video unit,
         i. For example, in case of horizontal flip, the samples in the above part of the reference template may be derived as follows:

1. temp[x+y*tempW]=cur[curW−1−x+(y−tempH)*curStride]
ii. For example, in case of horizontal flip, the samples in the right part of the reference template may be derived as follows:

1. temp[x+y*tempW]=cur[curW+tempW−1−x+y*curStride]
iii. For example, in case of vertical flip, the samples in the bottom part of the reference template may be derived as follows:

1. temp[x+y*tempW]=cur[x+(curH+tempH−1−y)*curStride]
iv. For example, in case of vertical flip, the samples in the left part of the reference template may be derived as follows:

1. temp[x+y*tempW]=cur[x−tempW+(curH−1−y]*curStride]
b. For example, when perform ARMC to a prediction list which includes at least one RRIBC coded candidate, the samples in a current template may be reordered (i.e., horizontal flip, vertical flip, and etc.), wherein “current template” refers to a template of the current block.
   a. In one example, the samples in the above part of the current template may be reordered, and/or the samples in the left part of the current template may be reordered.
   b. In one example, whether to reorder samples in the current template may be dependent on the flip type of the candidate.
   c. In one example, as shown in FIG. 15A, samples in the above part of the current template which is constructed from above samples neighboring to the current block, may be horizontally flipped.
   d. In one example, as shown in FIG. 15A, samples in the left part of the current template which is constructed from left samples neighboring to the current block, may be horizontally flipped.
      i. Furthermore, additionally, if the width of the left part of the current template is equal to a certain number (such as 1), then there may be no need to perform horizontally flip
   e. In one example, as shown in FIG. 15B, samples in the above part of the current template which is constructed from above samples neighboring to the current block, may be vertically flipped.
      i. Furthermore, additionally, if the height of the above part of the current template is equal to a certain number (such as 1), then there may be no need to perform vertically flip
   f. In one example, as shown in FIG. 15B, samples in the left part of the current template which is constructed from left samples neighboring to the current block, may be vertically flipped.
   g. In one example, suppose “temp” denotes the sample buffer of the above/right/left/bottom part of the current template, (tempW, tempH) denotes the width and height of the above/right/left/bottom part of the current template, (x,y) denotes the location of the top-left sample of the above/right/left/bottom part of the current template relative such part of the current template, “cur” denotes the sample buffer of the current video unit, (curW, curH) denotes the width and height of the current video unit, “curStride” denotes the stride of the sample buffer of current video unit,
      i. For example, in case of horizontal flip, the samples in the above part of the current template may be derived as follows:

1. temp[x+y*tempW]=cur[curW−1−x+(y−tempH)*curStride]
ii. For example, in case of horizontal flip, the samples in the right part of the current template may be derived as follows:

1. temp[x+y*tempW]=cur[curW+tempW−1−x+y*curStride]
iii. For example, in case of vertical flip, the samples in the bottom part of the current template may be derived as follows:

1. temp[x+y*tempW]=cur[x+(curH+tempH−1−y)*curStride]
iv. For example, in case of vertical flip, the samples in the left part of the current template may be derived as follows:

1. temp[x+y*tempW]=cur[x−tempW+(curH−1−y]*curStride]
c. For example, at most one template (e.g., either current template or reference template) may be reordered.
   a. In one example, if samples in the current template are reordered, then samples in the reference template may not be reordered.
   b. In one example, if samples in the reference template are reordered, then samples in the current template may not be reordered.
d. For example, the term “samples” in above aspects may refer to reconstruction samples.
e. For example, the term “samples” in above aspects may refer to prediction samples.
4.4 About the location of current/reference template and the template sample filling for a template-based methodology (e.g., the 4th problem and related issues), the following methods are proposed:
   a. For example, a template-based methodology may refer to a coding tool based on at least one template in the current picture and/or the reference picture.
      a. In one example, a template cost may be calculated by comparing the difference/error/distortion between a current template and a reference template.
      b. In one example, a template matching/refinement may be performed based on template cost.
      c. In one example, the template-based methodology may be IBC-TM merge mode.
      d. In one example, the template-based methodology may be TM based IBC AMVP candidate refinement.
      e. In one example, the template-based methodology may be ARMC based IBC mode.
      f. Furthermore, for example, RRIBC may be used to a video unit coded by the template-based methodology.
      g. Furthermore, for example, RRIBC may NOT be used to a video unit coded by the template-based methodology.
   b. For example, the location of (at least a part of) current template relative to the current video unit and the location of (at least a part of) the reference template relative to the reference video unit may be different.
      a. In one example, as illustrated in FIG. 11(a).
      b. In one example, as illustrated in FIG. 11(b).
   c. For example, the aspects in bullet 4.2 and/or its sub-bullets may be applicable to a second template-based methodology (in addition to ARMC).
      a. Furthermore, accordingly, the wordings “when perform ARMC to a prediction list which includes at least one RRIBC coded candidate” in bullet 4.2 and/or its sub-bullets may be replaced by “when applying RRIBC to a template-based methodology coded current video unit”.
      b. Furthermore, accordingly, the wordings “RRIBC coded candidate” in bullet 4.2 and/or its sub-bullets may be replaced by “RRIBC coded video unit”.
      c. Furthermore, for example, the reference template of a template-based methodology coded video unit may contain neighboring samples on the right and/or below and/or above and/or left side adjacent to the reference video unit.
      d. Furthermore, for example, the reference template of a template-based methodology coded video unit may contain samples within the reference video unit.
   d. Furthermore, for example, the aspects in bullet 4.2.b and/or its sub-bullets may be applicable to non-RRIBC coded video unit.
      a. In one example, a validation check may be applied to the reference template of non-RRIBC coded video unit.
      b. In one example, if the reference template of a non-RRIBC coded video unit exceeds a valid region, at least one sample within the valid region (e.g., inside the reference video unit) may be used instead to fill the reference template.
   e. Furthermore, in one example, the second template-based methodology in the above aspects may refer to any template-based methodology as illustrated in 4.4.a.
4.5 About the template sample reordering for a template-based methodology (e.g., the 5th problem and related issues), the following methods are proposed:
   a. For example, a template-based methodology may refer to a coding tool based on at least one template in the current picture and/or the reference picture.
      a. In one example, a template cost may be calculated by comparing the difference/error/distortion between a current template and a reference template.
      b. In one example, a template matching/refinement may be performed based on template cost.
      c. In one example, the template-based methodology may be IBC-TM merge mode.
      d. In one example, the template-based methodology may be TM based IBC AMVP candidate refinement.
      e. In one example, the template-based methodology may be ARMC based IBC mode.
      f. Furthermore, for example, RRIBC may be used to a video unit coded by the template-based methodology.
      g. Furthermore, for example, RRIBC may NOT be used to a video unit coded by the template-based methodology.
   b. For example, the aspects in bullet 4.3 and/or its sub-bullets may be applicable to a second template-based methodology (in addition to ARMC).
      a. Furthermore, accordingly, the wordings “when perform ARMC to a prediction list which includes at least one RRIBC coded candidate” in bullet 4.3 and/or its sub-bullets may be replaced by “when applying RRIBC to a template-based methodology coded current video unit”.
      b. Furthermore, accordingly, the wordings “RRIBC coded candidate” in bullet 4.3 and/or its sub-bullets may be replaced by “RRIBC coded video unit”.
      c. Furthermore, for example, (at least a part of) the samples in a reference template of a template-based methodology coded video unit may be reordered (i.e., horizontal flip, vertical flip, and etc.).
      d. Furthermore, alternatively, (at least a part of) the samples in a current template of a template-based methodology coded video unit may be reordered (i.e., horizontal flip, vertical flip, and etc.).
      e. Furthermore, for example, either (at least a part of) samples in the reference template or (at least a part of) samples in the current template may be reordered (but never both).
   c. Furthermore, in one example, the second template-based methodology in the above aspects may refer to any template-based methodology as illustrated in 4.5.a.

### General Aspects

4.6 Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
4.7 Whether to and/or how to apply the disclosed methods above may be signalled at PB/TB/CB/PU/TU/CU/VPDU/CTU/CTU row/slice/tile/sub-picture/other kinds of region contain more than one sample or pixel.
4.8 Whether to and/or how to apply the disclosed methods above may be dependent on coded information, such as block size, colour format, single/dual tree partitioning, colour component, slice/picture type.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. The term “image compression” may represent any variance of signal processing methods that compress or process the current input. The input images/videos include but not limited to the screen content and natural content.

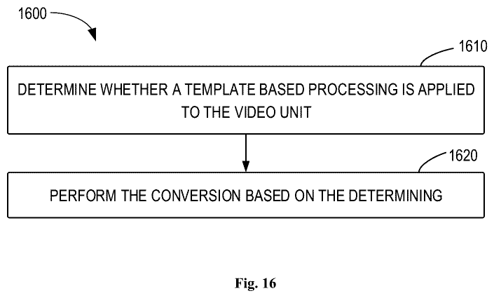

FIG. 16 illustrates a flowchart of a method 1600 for video processing in accordance with embodiments of the present disclosure. The method 1600 is implemented during a conversion between a video unit of a video and a bitstream of the video.

At block 1610, for a conversion between a video unit of a video and a bitstream of the video unit, it is determined that whether a template based processing is applied to the video unit. The template based processing is based on at least one template in at least one of: a current picture or a reference picture of the video unit. For example, a template-based methodology may refer to a coding tool based on at least one template in the current picture and/or the reference picture.

At block 1620, the conversion is performed based on the determining. In this way, the coding efficiency can be improved. In some embodiments, the conversion may include encoding the video unit into the bitstream. Alternatively, or in addition, the conversion may include decoding the video unit from the bitstream.

In some embodiments, a template cost is determined by comparing at least one of the followings between a current template and a reference template: a difference, an error, or a distortion. In some embodiments, a template matching or a template refinement is performed based on a template cost.

In some embodiments, the templated based process comprises one of: an intra block copy (IBC) template matching (TM) merge mode, a TM based IBC advanced motion vector prediction (AMVP) candidate refinement, or an adaptive reordering-based motion compensation (ARMC) based IBC mode.

In some embodiments, if the video unit is coded with the template based processing, a reconstruction reordered IBC (RRIBC) is applied to the video unit. Alternatively, if the video unit is coded with the template based processing, the RRIBC is not applied to the video unit.

In some embodiments, a location of at least a part of the current template relative to a current video unit and a location of at least a part of the reference template relative to a reference video unit are different.

In some embodiments, as shown in FIG. 15A, the current template is at above and left relative to the current video unit, and the reference template is at above and right relative to the reference video unit. In some embodiments, as shown in FIG. 15B, the current template is at above and left relative to the current video unit, and the reference template is at below and left relative to the reference video unit.

In some embodiments, if the template based processing in addition to the ARMC is applied to the prediction list, a second reference template that is different from a first reference template is used. In some other embodiments if the RRIBC is applied to the video unit that is coded with the template based processing, a second reference template that is different from a first reference template is used.

In some embodiments, a validation check is applied to a reference template of the at least one RRIBC coded motion candidate.

In some embodiments, the validation check is applied to check whether a right part of the reference template is within a valid area.

In some embodiments, the validation check is applied to check whether a bottom part of the reference template is within a valid area.

In some embodiments, the valid area is predefined by a set of rules related to coding information.

In some embodiments, the coding information comprises at least one of: a virtual pipeline data unit (VPDU) size, a largest coding unit (LCU) size, a tile boundary, a picture boundary, a slice boundary, or a tile row.

In above cases, in some embodiments, if a sample of the reference template is outside a valid area, another sample within the valid area is used instead to construct the reference template. In some embodiments, a valid sample nearest to an invalid sample is used. In some embodiments, a valid sample inside a reference block is used. In some embodiments, if at least one sample of the reference template is outside a valid area, the reference template of the at least one RRIBC coded motion candidate is treated as unavailable.

In some embodiments, the template based processing is not applied to the prediction list. Alternatively, RRIBC is not applied to the video unit that is coded with the template based processing. Alternatively, the ARMC is not applied to the video unit that is non-RRIBC coded video unit.

In some embodiments, if at least one sample of a right part of the reference template is outside a valid area, at least one sample on rightmost M columns inside a reference block is used instead to construct the reference template. In this case, M is equal to a width of the right part of the reference template.

In some embodiments, if at least one sample of a bottom part of the reference template is outside a valid area, at least one sample on top N rows inside a reference block is used instead to construct the reference template. In this case, M is equal to a width of the right part of the reference template.

In some embodiments, the second reference template is used to determine a template cost of at least one RRIBC coded video unit. In some embodiments, whether to use bottom samples or right samples neighboring to a reference block to construct a reference template of a reference lock is dependent on a flip type of the at least one RRIBC coded video unit.

In some embodiments, a validation check is applied to a reference template of the at least one RRIBC coded video unit. In some embodiments, a reference template of the video unit includes neighboring samples that are at least one of the following side adjacent to a reference video unit, a right side, a below side, an above side, or a left side. In some embodiments, a reference template of the video unit comprises samples within the reference video unit.

In some embodiments, if the ARMC is applied to the video unit that is a non-RRIBC coded video unit, a second reference template that is different from a first reference template is used. In this case, in some embodiments, a validation check is applied to a reference template of the non-RRIBC coded video unit.

In some other embodiments, the validation check is applied to check whether a right part of the reference template is within a valid area. In some embodiments, the validation check is applied to check whether a bottom part of the reference template is within a valid area.

In some embodiments, the valid area is predefined by a set of rules related to coding information. In some embodiments, the coding information comprises at least one of: a virtual pipeline data unit (VPDU) size, a largest coding unit (LCU) size, a tile boundary, a picture boundary, a slice boundary, or a tile row.

In some embodiments, if a sample of the reference template is outside a valid area, another sample within the valid area is used instead to construct the reference template. In some embodiments, a valid sample nearest to an invalid sample is used. In some embodiments, a valid sample inside a reference block is used.

In some embodiments, if at least one sample of the reference template is outside a valid area, the reference template of the non-RRIBC coded video unit is treated as unavailable. In some embodiments, the ARMC is not applied to the non-RRIBC coded video unit.

In some embodiments, if at least one sample of a right part of the reference template is outside a valid area, at least one sample on rightmost M columns inside a reference block is used instead to construct the reference template, where M is equal to a width of the right part of the reference template. In some embodiments, if at least one sample of a bottom part of the reference template is outside a valid area, at least one sample on top N rows inside a reference block is used instead to construct the reference template, where N is equal to a height of the bottom part of the reference template.

In some embodiments, if the reference template of the non-RRIBC coded video unit exceeds a valid region, at least one sample within the valid region is used instead to fill the reference template. In some embodiments, the first reference template is constructed from at least one of: left samples or above samples neighboring to a reference block. In some embodiments, the first reference template is used to determine a template cost of a motion candidate that is not coded with the RRIBC.

In some embodiments, the second reference template is constructed from at least one of bottom samples or right samples neighboring to a reference block. In some embodiments, the second reference template is used to determine a template cost of the at least one RRIBC coded motion candidate.

In some embodiments, whether to use bottom samples or right samples neighboring to a reference block to construct a reference template of a reference lock is dependent on a flip type of the at least one RRIBC coded motion candidate. In some embodiments, whether to use a second reference template or a first reference template is dependent on a flip type of a motion candidate.

In some embodiments, a second template is constructed from above and right samples neighboring to a reference block, and a first template is constructed from above and left samples neighboring to a current block. In some embodiments, a second template is constructed from bottom and left samples neighboring to a reference block, and a first template is constructed from above and left samples neighboring to a current block. In some embodiments, if the template based processing in addition to the ARMC is applied to the prediction list, samples in a reference template of a reference block of the video unit are reordered.

In some embodiments, if the RRIBC is applied to the video unit that is coded with the template based processing, samples in a reference template of a reference block of the video unit are reordered. In some embodiments, if the ARMC is applied to the video unit that is a RRIBC coded video unit, samples in a reference template of a reference block of the video unit are reordered.

In some embodiments, sample in an above part of the reference template are reordered. Alternatively, or in addition, samples in a right part of the reference template are reordered. In some embodiments, sample in a left part of the reference template are reordered. Alternatively, or in addition, samples in a bottom part of the reference template are reordered. In some embodiments, whether to reorder samples in the reference template is dependent on a flip type of a motion candidate.

In some embodiments, a horizontal flip processing is applied to samples in an above part of the reference template which is constructed from above samples neighboring to the reference block. In some embodiments, a horizontal flip processing is applied to samples in a right part of the reference template which is constructed from right samples neighboring to the reference block. In some embodiments, if a width of the right part of the reference template is equal to a predefined number, the horizontal flip processing is not applied.

In some embodiments, a vertical flip processing is applied to samples in a left part of the reference template which is constructed from left samples neighboring to the reference block. In some embodiments, a vertical flip processing is applied to samples in a bottom part of the reference template which is constructed from bottom samples neighboring to the reference block. In some embodiments, if a height of the bottom part of the reference template is equal to a predefined number, the vertical flip processing is not applied.

In one example, it may suppose “temp” denotes the sample buffer of the above/right/left/bottom part of the reference template, (tempW, tempH) denotes the width and height of the above/right/left/bottom part of the reference template, (x,y) denotes the location of the top-left sample of the above/right/left/bottom part of the reference template relative such part of the reference template, “cur” denotes the sample buffer of the current video unit, (curW, curH) denotes the width and height of the current video unit, “curStride” denotes the stride of the sample buffer of current video unit.

In some embodiments, if a horizontal flip processing is applied, samples in an above part of the reference template are derived as: temp[x+y*tempW]=cur[curW−1−x+(y−tempH)*curStride], and where temp represents a sample buffer of the above part of the reference template, (tempW, tempH) represents width and height of the above part of the reference template, (x,y) represents a location of a top-left sample of the above part of the reference template relative such part of the reference template, cur represents the sample buffer of the video unit, (curW, curH) represents width and height of the video unit, curStride represents a stride of the sample buffer of the video unit.

In some embodiments, if a horizontal flip processing is applied, samples in a right part of the reference template are derived as: temp[x+y*tempW]=cur[curW+tempW−1−x+y*curStride], and where temp represents a sample buffer of the right part of the reference template, (tempW, tempH) represents width and height of the right part of the reference template, (x,y) represents a location of a top-left sample of the right part of the reference template relative such part of the reference template, cur represents the sample buffer of the video unit, (curW, curH) represents width and height of the video unit, curStride represents a stride of the sample buffer of the video unit.

In some embodiments, if a vertical flip processing is applied, samples in a bottom part of the reference template are derived as: temp[x+y*tempW]=cur[x+(curH+tempH−1−y)*curStride]], and where temp represents a sample buffer of the bottom part of the reference template, (tempW, tempH) represents width and height of the bottom part of the reference template, (x,y) represents a location of a top-left sample of the bottom part of the reference template relative such part of the reference template, cur represents the sample buffer of the video unit, (curW, curH) represents width and height of the video unit, curStride represents a stride of the sample buffer of the video unit.

In some embodiments, if a vertical flip processing is applied, samples in a left part of the reference template are derived as: temp[x+y*tempW]=cur[x−tempW+(curH−1−y]*curStride], and where temp represents a sample buffer of the left part of the reference template, (tempW, tempH) represents width and height of the left part of the reference template, (x,y) represents a location of a top-left sample of the left part of the reference template relative such part of the reference template, cur represents the sample buffer of the video unit, (curW, curH) represents width and height of the video unit, curStride represents a stride of the sample buffer of the video unit.

In some embodiments, if the ARMC is applied to the prediction list, samples in a current template of a current block of the video unit are ordered. In some embodiments, if the ARMC is applied to the video unit that is a RRIBC coded video unit, samples in a current template of a current block of the video unit are ordered.

In some embodiments, sample in an above part of the current template are reordered. Alternatively, or in addition, samples in a left part of the current template are reordered. In some embodiments, whether to reorder samples in the current template is dependent on a flip type of a motion candidate.

In some embodiments, a horizontal flip processing is applied to samples in an above part of the current template which is constructed from above samples neighboring to the current block. In some embodiments, a horizontal flip processing is applied to samples in a left part of the reference template which is constructed from left samples neighboring to the current block. In some embodiments, if a width of the left part of the current template is equal to a predefined number, the horizontal flip processing is not applied.

In some embodiments, a vertical flip processing is applied to samples in an above part of the reference template which is constructed from above samples neighboring to the current block. In some embodiments, if a height of the above part of the current template is equal to a predefined number, the vertical flip processing is not applied. In some embodiments, a vertical flip processing is applied to samples in a left part of the current template which is constructed from left samples neighboring to the current block.

In one example, it may suppose “temp” denotes the sample buffer of the above/right/left/bottom part of the current template, (tempW, tempH) denotes the width and height of the above/right/left/bottom part of the current template, (x,y) denotes the location of the top-left sample of the above/right/left/bottom part of the current template relative such part of the current template, “cur” denotes the sample buffer of the current video unit, (curW, curH) denotes the width and height of the current video unit, “curStride” denotes the stride of the sample buffer of current video unit.

In some embodiments, if a horizontal flip processing is applied, samples in an above part of the current template are derived as: temp[x+y*tempW]=cur[curW−1−x+(y−tempH)*curStride], and where temp represents a sample buffer of the above part of the current template, (tempW, tempH) represents width and height of the above part of the current template, (x,y) represents a location of a top-left sample of the above part of the current template relative such part of the current template, cur represents the sample buffer of the video unit, (curW, curH) represents width and height of the video unit, curStride represents a stride of the sample buffer of the video unit.

In some embodiments, if a horizontal flip processing is applied, samples in a right part of the current template are derived as: temp[x+y*tempW]=cur[curW+tempW−1−x+y*curStride], and where temp represents a sample buffer of the right part of the current template, (tempW, tempH) represents width and height of the right part of the current template, (x,y) represents a location of a top-left sample of the right part of the current template relative such part of the current template, cur represents the sample buffer of the video unit, (curW, curH) represents width and height of the video unit, curStride represents a stride of the sample buffer of the video unit.

In some embodiments, if a vertical flip processing is applied, samples in a bottom part of the current template are derived as: temp[x+y*tempW]=cur[x+(curH+tempH−1−y)*curStride]], and where temp represents a sample buffer of the bottom part of the current template, (tempW, tempH) represents width and height of the bottom part of the current template, (x,y) represents a location of a top-left sample of the bottom part of the current template relative such part of the current template, cur represents the sample buffer of the video unit, (curW, curH) represents width and height of the video unit, curStride represents a stride of the sample buffer of the video unit.

In some embodiments, if a vertical flip processing is applied, samples in a left part of the current template are derived as: temp[x+y*tempW]=cur[x−tempW+(curH−1−y]*curStride], and where temp represents a sample buffer of the left part of the current template, (tempW, tempH) represents width and height of the left part of the current template, (x,y) represents a location of a top-left sample of the left part of the current template relative such part of the current template, cur represents the sample buffer of the video unit, (curW, curH) represents width and height of the video unit, curStride represents a stride of the sample buffer of the video unit.

In some embodiments, at most one template is reordered. In some embodiments, samples in a current template of a current block of the video unit are reordered, and samples in a reference template of a reference block of the video unit are not reordered. In some embodiments, samples in a reference template of a reference block of the video unit are reordered, and samples in a current template of a current block of the video unit are not reordered.

In some embodiments, at least part of samples in the reference template of the video unit that is coded with the template based processing are ordered. In some embodiments, at least part of samples in the current template of the video unit that is coded with the template based processing are ordered. In some embodiments, at least part of samples in the reference template or at least part of samples in the current template of the video unit that is coded with the template based processing are ordered. In some embodiments, samples comprise at least one of: reconstruction samples or prediction samples.

In some embodiments, an indication of whether to and/or how to determine whether the template based processing is applied to the video unit is indicated at one of the followings: sequence level, group of pictures level, picture level, slice level, or tile group level. In some embodiments, an indication of whether to and/or how to determine whether the template based processing is applied to the video unit is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header. In some embodiments, an indication of whether to and/or how to determine whether the template based processing is applied to the video unit is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 1600 further comprises: determining, based on coded information of the video unit, whether and/or how to determine whether the template based processing is applied to the video unit. The coded information may include at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: determining whether a template based processing is applied to a video unit of the video, wherein the template based processing is based on at least one template in at least one of: a current picture or a reference picture of the video unit; and generating a bitstream based on the determining.

According to still further embodiments of the present disclosure, a method for storing bitstream of a video is provided. The method comprises: determining whether a template based processing is applied to a video unit of the video, wherein the template based processing is based on at least one template in at least one of: a current picture or a reference picture of the video unit; generating a bitstream based on the determining; and storing the bitstream in a non-transitory computer-readable recording medium.

Implementations of the present disclosure can be described in view of the following clauses, the features of which can be combined in any reasonable manner.

Clause 1. A method of video processing, comprising: determining, for a conversion between a video unit of a video and a bitstream of the video unit, whether a template based processing is applied to the video unit, wherein the template based processing is based on at least one template in at least one of: a current picture or a reference picture of the video unit; and performing the conversion based on the determining.

Clause 2. The method of clause 1, wherein a template cost is determined by comparing at least one of the followings between a current template and a reference template: a difference, an error, or a distortion.

Clause 3. The method of clause 1, wherein a template matching or a template refinement is performed based on a template cost.

Clause 4. The method of clause 1, wherein the templated based process comprises one of: an intra block copy (IBC) template matching (TM) merge mode, a TM based IBC advanced motion vector prediction (AMVP) candidate refinement, or an adaptive reordering-based motion compensation (ARMC) based IBC mode.

Clause 5. The method of clause 1, wherein in accordance with a determination that the video unit is coded with the template based processing, a reconstruction reordered IBC (RRIBC) is applied to the video unit, or wherein in accordance with a determination that the video unit is coded with the template based processing, the RRIBC is not applied to the video unit.

Clause 6. The method of clause 1, wherein a location of at least a part of the current template relative to a current video unit and a location of at least a part of the reference template relative to a reference video unit are different.

Clause 7. The method of clause 1, wherein the current template is at above and left relative to the current video unit, and the reference template is at above and right relative to the reference video unit.

Clause 8. The method of clause 1, wherein the current template is at above and left relative to the current video unit, and the reference template is at below and left relative to the reference video unit.

Clause 9. The method of any of clauses 1-8, where if the template based processing in addition to the ARMC is applied to the prediction list, a second reference template that is different from a first reference template is used.

Clause 10. The method of any of clauses 1-8, where if the RRIBC is applied to the video unit that is coded with the template based processing, a second reference template that is different from a first reference template is used.

Clause 11. The method of clause 9 or 10, wherein a validation check is applied to a reference template of the at least one RRIBC coded motion candidate.

Clause 12. The method of clause 11, wherein the validation check is applied to check whether a right part of the reference template is within a valid area.

Clause 13. The method of clause 11, wherein the validation check is applied to check whether a bottom part of the reference template is within a valid area.

Clause 14. The method of clause 12 or 13, wherein the valid area is predefined by a set of rules related to coding information.

Clause 15. The method of clause 14, wherein the coding information comprises at least one of: a virtual pipeline data unit (VPDU) size, a largest coding unit (LCU) size, a tile boundary, a picture boundary, a slice boundary, or a tile row.

Clause 16. The method of clause 11, wherein if a sample of the reference template is outside a valid area, another sample within the valid area is used instead to construct the reference template.

Clause 17. The method of clause 16, wherein a valid sample nearest to an invalid sample is used.

Clause 18. The method of clause 16, wherein a valid sample inside a reference block is used.

Clause 19. The method of clause 11, wherein if at least one sample of the reference template is outside a valid area, the reference template of the at least one RRIBC coded motion candidate is treated as unavailable.

Clause 20. The method of clause 19, wherein the template based processing is not applied to the prediction list, or wherein the RRIBC is not applied to the video unit that is coded with the template based processing, or wherein the ARMC is not applied to the video unit that is non-RRIBC coded video unit.

Clause 21. The method of clause 11, wherein if at least one sample of a right part of the reference template is outside a valid area, at least one sample on rightmost M columns inside a reference block is used instead to construct the reference template, wherein M is equal to a width of the right part of the reference template.

Clause 22. The method of clause 11, wherein if at least one sample of a bottom part of the reference template is outside a valid area, at least one sample on top N rows inside a reference block is used instead to construct the reference template, wherein N is equal to a height of the bottom part of the reference template.

Clause 23. The method of clause 9 or 10, wherein the second reference template is used to determine a template cost of at least one RRIBC coded video unit.

Clause 24. The method of clause 23, wherein whether to use bottom samples or right samples neighboring to a reference block to construct a reference template of a reference lock is dependent on a flip type of the at least one RRIBC coded video unit.

Clause 25. The method of clause 9 or 10, wherein a validation check is applied to a reference template of the at least one RRIBC coded video unit.

Clause 26. The method of clause 9 or 10, wherein a reference template of the video unit includes neighboring samples that are at least one of the following side adjacent to a reference video unit, a right side, a below side, an above side, or a left side.

Clause 27. The method of clause 9 or 10, wherein a reference template of the video unit comprises samples within the reference video unit.

Clause 28. The method of any of clauses 1-8, wherein if the ARMC is applied to the video unit that is a non-RRIBC coded video unit, a second reference template that is different from a first reference template is used.

Clause 29. The method of clause 28, wherein a validation check is applied to a reference template of the non-RRIBC coded video unit.

Clause 30. The method of clause 29, wherein the validation check is applied to check whether a right part of the reference template is within a valid area.

Clause 31. The method of clause 29, wherein the validation check is applied to check whether a bottom part of the reference template is within a valid area.

Clause 32. The method of clause 30 or 31, wherein the valid area is predefined by a set of rules related to coding information.

Clause 33. The method of clause 32, wherein the coding information comprises at least one of: a virtual pipeline data unit (VPDU) size, a largest coding unit (LCU) size, a tile boundary, a picture boundary, a slice boundary, or a tile row.

Clause 34. The method of clause 29, wherein if a sample of the reference template is outside a valid area, another sample within the valid area is used instead to construct the reference template.

Clause 35. The method of clause 34, wherein a valid sample nearest to an invalid sample is used.

Clause 36. The method of clause 34, wherein a valid sample inside a reference block is used.

Clause 37. The method of clause 29, wherein if at least one sample of the reference template is outside a valid area, the reference template of the non-RRIBC coded video unit is treated as unavailable.

Clause 38. The method of clause 37, wherein the ARMC is not applied to the non-RRIBC coded video unit.

Clause 39. The method of clause 29, wherein if at least one sample of a right part of the reference template is outside a valid area, at least one sample on rightmost M columns inside a reference block is used instead to construct the reference template, wherein M is equal to a width of the right part of the reference template.

Clause 40. The method of clause 29, wherein if at least one sample of a bottom part of the reference template is outside a valid area, at least one sample on top N rows inside a reference block is used instead to construct the reference template, wherein N is equal to a height of the bottom part of the reference template.

Clause 41. The method of clause 29, wherein if the reference template of the non-RRIBC coded video unit exceeds a valid region, at least one sample within the valid region is used instead to fill the reference template.

Clause 42. The method of any of clauses 9, 10 or 28, wherein the first reference template is constructed from at least one of: left samples or above samples neighboring to a reference block.

Clause 43. The method of clause 42, wherein the first reference template is used to determine a template cost of a motion candidate that is not coded with the RRIBC.

Clause 44. The method of any of clauses 9, 10 or 28, wherein the second reference template is constructed from at least one of bottom samples or right samples neighboring to a reference block.

Clause 45. The method of any of clauses 9, 10 or 28, wherein the second reference template is used to determine a template cost of the at least one RRIBC coded motion candidate.

Clause 46. The method of any of clauses 9, 10 or 28, wherein whether to use bottom samples or right samples neighboring to a reference block to construct a reference template of a reference lock is dependent on a flip type of the at least one RRIBC coded motion candidate.

Clause 47. The method of any of clauses 9, 10 or 28, wherein whether to use a second reference template or a first reference template is dependent on a flip type of a motion candidate.

Clause 48. The method of any of clauses 9, 10 or 28, wherein a second template is constructed from above and right samples neighboring to a reference block, and a first template is constructed from above and left samples neighboring to a current block.

Clause 49. The method of any of clauses 9, 10 or 28, wherein a second template is constructed from bottom and left samples neighboring to a reference block, and a first template is constructed from above and left samples neighboring to a current block.

Clause 50. The method of any of clauses 1-8, wherein if the template based processing in addition to the ARMC is applied to the prediction list, samples in a reference template of a reference block of the video unit are reordered.

Clause 51. The method of any of clauses 1-8, where if the RRIBC is applied to the video unit that is coded with the template based processing, samples in a reference template of a reference block of the video unit are reordered.

Clause 52. The method of any of clauses 1-8, wherein if the ARMC is applied to the video unit that is a RRIBC coded video unit, samples in a reference template of a reference block of the video unit are reordered.

Clause 53. The method of any of clauses 50-52, wherein sample in an above part of the reference template are reordered, and/or wherein samples in a right part of the reference template are reordered.

Clause 54. The method of any of clauses 50-52, wherein sample in a left part of the reference template are reordered, and/or wherein samples in a bottom part of the reference template are reordered.

Clause 55. The method of any of clauses 50-52, wherein whether to reorder samples in the reference template is dependent on a flip type of a motion candidate.

Clause 56. The method of any of clauses 50-52, wherein a horizontal flip processing is applied to samples in an above part of the reference template which is constructed from above samples neighboring to the reference block.

Clause 57. The method of any of clauses 50-52, wherein a horizontal flip processing is applied to samples in a right part of the reference template which is constructed from right samples neighboring to the reference block.

Clause 58. The method of clause 57, wherein if a width of the right part of the reference template is equal to a predefined number, the horizontal flip processing is not applied.

Clause 59. The method of any of clauses 50-52, wherein a vertical flip processing is applied to samples in a left part of the reference template which is constructed from left samples neighboring to the reference block.

Clause 60. The method of any of clauses 50-52, wherein a vertical flip processing is applied to samples in a bottom part of the reference template which is constructed from bottom samples neighboring to the reference block.

Clause 61. The method of clause 60, wherein if a height of the bottom part of the reference template is equal to a predefined number, the vertical flip processing is not applied.

Clause 62. The method of any of clauses 50-52, wherein if a horizontal flip processing is applied, samples in an above part of the reference template are derived as: temp[x+y*tempW]=cur[curW−1−x+ (y−tempH)*curStride], and wherein temp represents a sample buffer of the above part of the reference template, (tempW, tempH) represents width and height of the above part of the reference template, (x,y) represents a location of a top-left sample of the above part of the reference template relative such part of the reference template, cur represents the sample buffer of the video unit, (curW, curH) represents width and height of the video unit, curStride represents a stride of the sample buffer of the video unit.

Clause 63. The method of any of clauses 50-52, wherein if a horizontal flip processing is applied, samples in a right part of the reference template are derived as: temp[x+y*tempW]=cur[curW+tempW−1−x+y*curStride], and wherein temp represents a sample buffer of the right part of the reference template, (tempW, tempH) represents width and height of the right part of the reference template, (x,y) represents a location of a top-left sample of the right part of the reference template relative such part of the reference template, cur represents the sample buffer of the video unit, (curW, curH) represents width and height of the video unit, curStride represents a stride of the sample buffer of the video unit.

Clause 64. The method of any of clauses 50-52, wherein if a vertical flip processing is applied, samples in a bottom part of the reference template are derived as: temp[x+y*tempW]=cur[x+(curH+tempH−1−y)*curStride]], and wherein temp represents a sample buffer of the bottom part of the reference template, (tempW, tempH) represents width and height of the bottom part of the reference template, (x,y) represents a location of a top-left sample of the bottom part of the reference template relative such part of the reference template, cur represents the sample buffer of the video unit, (curW, curH) represents width and height of the video unit, curStride represents a stride of the sample buffer of the video unit.

Clause 65. The method of any of clauses 50-52, wherein if a vertical flip processing is applied, samples in a left part of the reference template are derived as: temp[x+y*tempW]=cur[x−tempW+(curH−1−y]*curStride], and wherein temp represents a sample buffer of the left part of the reference template, (tempW, tempH) represents width and height of the left part of the reference template, (x,y) represents a location of a top-left sample of the left part of the reference template relative such part of the reference template, cur represents the sample buffer of the video unit, (curW, curH) represents width and height of the video unit, curStride represents a stride of the sample buffer of the video unit.

Clause 66. The method of any of clauses 1-8, wherein if the ARMC is applied to the prediction list, samples in a current template of a current block of the video unit are ordered.

Clause 67. The method of any of clauses 1-8, wherein if the ARMC is applied to the video unit that is a RRIBC coded video unit, samples in a current template of a current block of the video unit are ordered.

Clause 68. The method of clause 66 or 67, wherein sample in an above part of the current template are reordered, and/or wherein samples in a left part of the current template are reordered.

Clause 69. The method of clause 66 or 67, wherein whether to reorder samples in the current template is dependent on a flip type of a motion candidate.

Clause 70. The method of clause 66 or 67, wherein a horizontal flip processing is applied to samples in an above part of the current template which is constructed from above samples neighboring to the current block.

Clause 71. The method of clause 66 or 67, wherein a horizontal flip processing is applied to samples in a left part of the reference template which is constructed from left samples neighboring to the current block.

Clause 72. The method of clause 71, wherein if a width of the left part of the current template is equal to a predefined number, the horizontal flip processing is not applied.

Clause 73. The method of clause 66 or 67, wherein a vertical flip processing is applied to samples in an above part of the reference template which is constructed from above samples neighboring to the current block.

Clause 74. The method of clause 73, wherein if a height of the above part of the current template is equal to a predefined number, the vertical flip processing is not applied.

Clause 75. The method of clause 66 or 67, wherein a vertical flip processing is applied to samples in a left part of the current template which is constructed from left samples neighboring to the current block.

Clause 76. The method of clause 66 or 67, wherein if a horizontal flip processing is applied, samples in an above part of the current template are derived as: temp[x+y*tempW]=cur[curW−1−x+(y−tempH)*curStride], and wherein temp represents a sample buffer of the above part of the current template, (tempW, tempH) represents width and height of the above part of the current template, (x,y) represents a location of a top-left sample of the above part of the current template relative such part of the current template, cur represents the sample buffer of the video unit, (curW, curH) represents width and height of the video unit, curStride represents a stride of the sample buffer of the video unit.

Clause 77. The method of clause 66 or 67, wherein if a horizontal flip processing is applied, samples in a right part of the current template are derived as: temp[x+y*tempW]=cur[curW+tempW−1−x+y*curStride], and wherein temp represents a sample buffer of the right part of the current template, (tempW, tempH) represents width and height of the right part of the current template, (x,y) represents a location of a top-left sample of the right part of the current template relative such part of the current template, cur represents the sample buffer of the video unit, (curW, curH) represents width and height of the video unit, curStride represents a stride of the sample buffer of the video unit.

Clause 78. The method of clause 66 or 67, wherein if a vertical flip processing is applied, samples in a bottom part of the current template are derived as: temp[x+y*tempW]=cur[x+(curH+tempH−1−y)*curStride]], and wherein temp represents a sample buffer of the bottom part of the current template, (tempW, tempH) represents width and height of the bottom part of the current template, (x,y) represents a location of a top-left sample of the bottom part of the current template relative such part of the current template, cur represents the sample buffer of the video unit, (curW, curH) represents width and height of the video unit, curStride represents a stride of the sample buffer of the video unit.

Clause 79. The method of clause 66 or 67, wherein if a vertical flip processing is applied, samples in a left part of the current template are derived as: temp[x+y*tempW]=cur[x−tempW+(curH−1−y] *curStride], and wherein temp represents a sample buffer of the left part of the current template, (tempW, tempH) represents width and height of the left part of the current template, (x,y) represents a location of a top-left sample of the left part of the current template relative such part of the current template, cur represents the sample buffer of the video unit, (curW, curH) represents width and height of the video unit, curStride represents a stride of the sample buffer of the video unit.

Clause 80. The method of clause 66 or 67, wherein at most one template is reordered.

Clause 81. The method of clause 80, wherein samples in a current template of a current block of the video unit are reordered, and samples in a reference template of a reference block of the video unit are not reordered.

Clause 82. The method of clause 80, wherein samples in a reference template of a reference block of the video unit are reordered, and samples in a current template of a current block of the video unit are not reordered.

Clause 83. The method of clause 50, wherein at least part of samples in the reference template of the video unit that is coded with the template based processing are ordered.

Clause 84. The method of clause 50, wherein at least part of samples in the current template of the video unit that is coded with the template based processing are ordered.

Clause 85. The method of clause 50, wherein at least part of samples in the reference template or at least part of samples in the current template of the video unit that is coded with the template based processing are ordered.

Clause 86. The method of any of clauses 9-85, wherein samples comprise at least one of: reconstruction samples or prediction samples.

Clause 87. The method of any of clauses 1-86, wherein an indication of whether to and/or how to determine whether the template based processing is applied to the video unit is indicated at one of the followings: sequence level, group of pictures level, picture level, slice level, or tile group level.

Clause 88. The method of any of clauses 1-86, wherein an indication of whether to and/or how to determine whether the template based processing is applied to the video unit is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 89. The method of any of clauses 1-86, wherein an indication of whether to and/or how to determine whether the template based processing is applied to the video unit is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 90. The method of any of clauses 1-86, further comprising: determining, based on coded information of the video unit, whether and/or how to determine whether the template based processing is applied to the video unit, the coded information including at least one of: a block size, a colour format, a single and/or dual tree partitioning, a colour component, a slice type, or a picture type.

Clause 91. The method of any of clauses 1-90, wherein the conversion includes encoding the video unit into the bitstream.

Clause 92. The method of any of clauses 1-90, wherein the conversion includes decoding the video unit from the bitstream.

Clause 93. An apparatus for video processing comprising a processor and a non-transitory memory with instructions thereon, wherein the instructions upon execution by the processor, cause the processor to perform a method in accordance with any of clauses 1-92.

Clause 94. A non-transitory computer-readable storage medium storing instructions that cause a processor to perform a method in accordance with any of clauses 1-92.

Clause 95. A non-transitory computer-readable recording medium storing a bitstream of a video which is generated by a method performed by an apparatus for video processing, wherein the method comprises: determining whether a template based processing is applied to a video unit of the video, wherein the template based processing is based on at least one template in at least one of: a current picture or a reference picture of the video unit; and generating a bitstream based on the determining.

Clause 96. A method for storing a bitstream of a video, comprising: determining whether a template based processing is applied to a video unit of the video, wherein the template based processing is based on at least one template in at least one of: a current picture or a reference picture of the video unit; generating a bitstream based on the determining; and storing the bitstream in a non-transitory computer-readable recording medium.

### Example Device

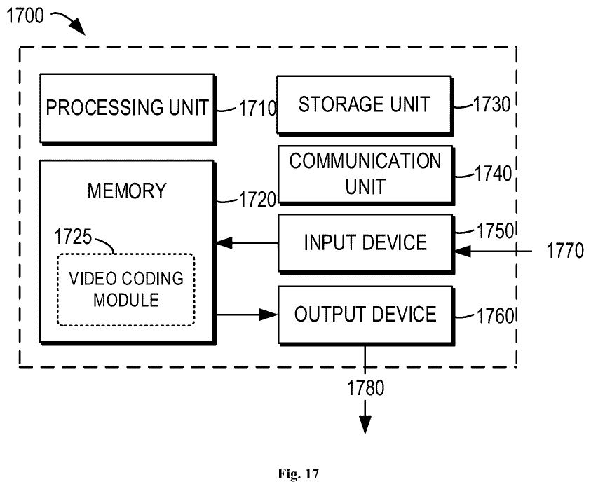

FIG. 17 illustrates a block diagram of a computing device 1700 in which various embodiments of the present disclosure can be implemented. The computing device 1700 may be implemented as or included in the source device 110 (or the video encoder 114 or 200) or the destination device 120 (or the video decoder 124 or 300).

It would be appreciated that the computing device 1700 shown in FIG. 17 is merely for purpose of illustration, without suggesting any limitation to the functions and scopes of the embodiments of the present disclosure in any manner.

As shown in FIG. 17, the computing device 1700 includes a general-purpose computing device 1700. The computing device 1700 may at least comprise one or more processors or processing units 1710, a memory 1720, a storage unit 1730, one or more communication units 1740, one or more input devices 1750, and one or more output devices 1760.

In some embodiments, the computing device 1700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1700 can support any type of interface to a user (such as “wearable” circuitry and the like).

The processing unit 1710 may be a physical or virtual processor and can implement various processes based on programs stored in the memory 1720. In a multi-processor system, multiple processing units execute computer executable instructions in parallel so as to improve the parallel processing capability of the computing device 1700. The processing unit 1710 may also be referred to as a central processing unit (CPU), a microprocessor, a controller or a microcontroller.

The computing device 1700 typically includes various computer storage medium. Such medium can be any medium accessible by the computing device 1700, including, but not limited to, volatile and non-volatile medium, or detachable and non-detachable medium. The memory 1720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1730 may be any detachable or non-detachable medium and may include a machine-readable medium such as a memory, flash memory drive, magnetic disk or another other media, which can be used for storing information and/or data and can be accessed in the computing device 1700.

The computing device 1700 may further include additional detachable/non-detachable, volatile/non-volatile memory medium. Although not shown in FIG. 17, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1740 communicates with a further computing device via the communication medium. In addition, the functions of the components in the computing device 1700 can be implemented by a single computing cluster or multiple computing machines that can communicate via communication connections. Therefore, the computing device 1700 can operate in a networked environment using a logical connection with one or more other servers, networked personal computers (PCs) or further general network nodes.

The input device 1750 may be one or more of a variety of input devices, such as a mouse, keyboard, tracking ball, voice-input device, and the like. The output device 1760 may be one or more of a variety of output devices, such as a display, loudspeaker, printer, and the like. By means of the communication unit 1740, the computing device 1700 can further communicate with one or more external devices (not shown) such as the storage devices and display device, with one or more devices enabling the user to interact with the computing device 1700, or any devices (such as a network card, a modem and the like) enabling the computing device 1700 to communicate with one or more other computing devices, if required. Such communication can be performed via input/output (I/O) interfaces (not shown).

In some embodiments, instead of being integrated in a single device, some or all components of the computing device 1700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1700 may be used to implement video encoding/decoding in embodiments of the present disclosure. The memory 1720 may include one or more video coding modules 1725 having one or more program instructions. These modules are accessible and executable by the processing unit 1710 to perform the functionalities of the various embodiments described herein.

In the example embodiments of performing video encoding, the input device 1750 may receive video data as an input 1770 to be encoded. The video data may be processed, for example, by the video coding module 1725, to generate an encoded bitstream. The encoded bitstream may be provided via the output device 1760 as an output 1780.

In the example embodiments of performing video decoding, the input device 1750 may receive an encoded bitstream as the input 1770. The encoded bitstream may be processed, for example, by the video coding module 1725, to generate decoded video data. The decoded video data may be provided via the output device 1760 as the output 1780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, for a conversion between a video unit of a video and a bitstream of the video, whether a template based processing is applied to the video unit, wherein the template based processing is based on at least one template in at least one of: a current picture or a reference picture of the video unit; and
performing the conversion based on the determining.

2. The method of claim 1, wherein a template cost is determined by comparing at least one of the following between a current template and a reference template: a difference, an error, or a distortion, and/or
wherein a template matching or a template refinement is performed based on a template cost, and/or
wherein the template based processing comprises one of: an intra block copy (IBC) template matching (TM) merge mode, a TM based IBC advanced motion vector prediction (AMVP) candidate refinement, or an adaptive reordering-based motion compensation (ARMC) based IBC mode, and/or
wherein in accordance with a determination that the video unit is coded with the template based processing, a reconstruction reordered IBC (RRIBC) is applied to the video unit, or in accordance with a determination that the video unit is coded with the template based processing, the RRIBC is not applied to the video unit, and/or
wherein a location of at least a part of the current template relative to a current video unit and a location of at least a part of the reference template relative to a reference video unit are different, and/or
wherein the current template is at above and left relative to the current video unit, and the reference template is at above and right relative to the reference video unit, and/or
wherein the current template is at above and left relative to the current video unit, and the reference template is at below and left relative to the reference video unit.

3. The method of claim 1, wherein if the template based processing in addition to the ARMC is applied to a prediction list, a second reference template that is different from a first reference template is used, and/or
wherein if the RRIBC is applied to the video unit that is coded with the template based processing, a second reference template that is different from a first reference template is used, and/or
wherein if the ARMC is applied to the video unit that is a non-RRIBC coded video unit, a second reference template that is different from a first reference template is used, and/or
wherein if the template based processing in addition to the ARMC is applied to the prediction list, samples in a reference template of a reference block of the video unit are reordered, and/or
wherein if the RRIBC is applied to the video unit that is coded with the template based processing, samples in a reference template of a reference block of the video unit are reordered, and/or
wherein if the ARMC is applied to the video unit that is a RRIBC coded video unit, samples in a reference template of a reference block of the video unit are reordered, and/or
wherein if the ARMC is applied to the prediction list, samples in a current template of a current block of the video unit are ordered, or
wherein if the ARMC is applied to the video unit that is a RRIBC coded video unit, samples in a current template of a current block of the video unit are ordered.

4. The method of claim 3, wherein a validation check is applied to a reference template of at least one RRIBC coded motion candidate, and/or
wherein the second reference template is used to determine a template cost of at least one RRIBC coded video unit, and/or
wherein a validation check is applied to a reference template of the at least one RRIBC coded video unit, and/or
wherein a reference template of the video unit includes neighboring samples that are at least one of the following sides adjacent to a reference video unit: a right side, a below side, an above side, or a left side, and/or
wherein a reference template of the video unit comprises samples within the reference video unit.

5. The method of claim 4, wherein the validation check is applied to check whether a right part of the reference template is within a valid area, and/or
wherein the validation check is applied to check whether a bottom part of the reference template is within a valid area, and/or
wherein if a sample of the reference template is outside a valid area, another sample within the valid area is used instead to construct the reference template, and/or
wherein if at least one sample of the reference template is outside a valid area, the reference template of the at least one RRIBC coded motion candidate is treated as unavailable, and/or
wherein if at least one sample of a right part of the reference template is outside a valid area, at least one sample on rightmost M columns inside a reference block is used instead to construct the reference template, wherein M is equal to a width of the right part of the reference template, or if at least one sample of a bottom part of the reference template is outside a valid area, at least one sample on top N rows inside a reference block is used instead to construct the reference template, wherein N is equal to a height of the bottom part of the reference template, and/or
wherein whether to use bottom samples or right samples neighboring to a reference block to construct a reference template of a reference lock is dependent on a flip type of the at least one RRIBC coded video unit.

6. The method of claim 5, wherein the valid area is predefined by a set of rules related to coding information, and wherein the coding information comprises at least one of: a virtual pipeline data unit (VPDU) size, a largest coding unit (LCU) size, a tile boundary, a picture boundary, a slice boundary, or a tile row, and/or
wherein a valid sample nearest to an invalid sample is used, and/or wherein a valid sample inside a reference block is used, and/or
wherein the template based processing is not applied to the prediction list, or wherein the RRIBC is not applied to the video unit that is coded with the template based processing, or wherein the ARMC is not applied to the video unit that is non-RRIBC coded video unit.

7. The method of claim 3, wherein a validation check is applied to a reference template of the non-RRIBC coded video unit.

8. The method of claim 7, wherein the validation check is applied to check whether a right part of the reference template is within a valid area, and/or
wherein the validation check is applied to check whether a bottom part of the reference template is within a valid area, and/or
wherein if a sample of the reference template is outside a valid area, another sample within the valid area is used instead to construct the reference template, and/or
wherein if at least one sample of the reference template is outside a valid area, the reference template of the non-RRIBC coded video unit is treated as unavailable, and/or
wherein if at least one sample of a right part of the reference template is outside a valid area, at least one sample on rightmost M columns inside a reference block is used instead to construct the reference template, wherein M is equal to a width of the right part of the reference template, and/or
wherein if at least one sample of a bottom part of the reference template is outside a valid area, at least one sample on top N rows inside a reference block is used instead to construct the reference template, wherein N is equal to a height of the bottom part of the reference template, and/or
wherein if the reference template of the non-RRIBC coded video unit exceeds a valid region, at least one sample within the valid region is used instead to fill the reference template.

9. The method of claim 7, wherein a valid area is predefined by a set of rules related to coding information, and wherein the coding information comprises at least one of: a virtual pipeline data unit (VPDU) size, a largest coding unit (LCU) size, a tile boundary, a picture boundary, a slice boundary, or a tile row, and/or
wherein a valid sample nearest to an invalid sample is used, and/or
wherein a valid sample inside a reference block is used, and/or
wherein the ARMC is not applied to the non-RRIBC coded video unit.

10. The method of claim 3, wherein the first reference template is constructed from at least one of: left samples or above samples neighboring to a reference block, and/or
wherein the second reference template is constructed from at least one of bottom samples or right samples neighboring to a reference block, and/or
wherein the second reference template is used to determine a template cost of the at least one RRIBC coded motion candidate, and/or
wherein whether to use bottom samples or right samples neighboring to a reference block to construct a reference template of a reference lock is dependent on a flip type of the at least one RRIBC coded motion candidate, and/or
wherein whether to use a second reference template or a first reference template is dependent on a flip type of a motion candidate, and/or
wherein a second template is constructed from above and right samples neighboring to a reference block, and a first template is constructed from above and left samples neighboring to a current block, and/or
wherein a second template is constructed from bottom and left samples neighboring to a reference block, and a first template is constructed from above and left samples neighboring to a current block, and/or
wherein sample in an above part of the reference template are reordered, and/or
wherein samples in a right part of the reference template are reordered, and/or
wherein sample in a left part of the reference template are reordered, and/or
wherein samples in a bottom part of the reference template are reordered, and/or
wherein whether to reorder samples in the reference template is dependent on a flip type of a motion candidate, and/or
wherein a horizontal flip processing is applied to samples in an above part of the reference template which is constructed from above samples neighboring to the reference block, and/or
wherein a horizontal flip processing is applied to samples in a right part of the reference template which is constructed from right samples neighboring to the reference block, and/or
wherein a vertical flip processing is applied to samples in a left part of the reference template which is constructed from left samples neighboring to the reference block, and/or
wherein a vertical flip processing is applied to samples in a bottom part of the reference template which is constructed from bottom samples neighboring to the reference block, and/or
wherein sample in an above part of the current template are reordered, and/or
wherein samples in a left part of the current template are reordered, and/or
wherein whether to reorder samples in the current template is dependent on a flip type of a motion candidate, and/or
wherein a horizontal flip processing is applied to samples in an above part of the current template which is constructed from above samples neighboring to the current block, and/or
wherein a horizontal flip processing is applied to samples in a left part of the reference template which is constructed from left samples neighboring to the current block, and/or
wherein a vertical flip processing is applied to samples in an above part of the reference template which is constructed from above samples neighboring to the current block, and/or
wherein a vertical flip processing is applied to samples in a left part of the current template which is constructed from left samples neighboring to the current block, and/or
wherein at most one template is reordered, and/or
wherein samples in a current template of a current block of the video unit are reordered, and samples in a reference template of a reference block of the video unit are not reordered, and/or
wherein samples in a reference template of a reference block of the video unit are reordered, and samples in a current template of a current block of the video unit are not reordered, and/or
wherein at least part of samples in the reference template of the video unit that is coded with the template based processing are ordered, and/or
wherein at least part of samples in the current template of the video unit that is coded with the template based processing are ordered, and/or
wherein at least part of samples in the reference template or at least part of samples in the current template of the video unit that is coded with the template based processing are ordered, and/or
wherein samples comprise at least one of: reconstruction samples or prediction samples.

11. The method of claim 10, wherein the first reference template is used to determine a template cost of a motion candidate that is not coded with the RRIBC.

12. The method of claim 10, wherein if a width of the right part of the reference template is equal to a predefined number, the horizontal flip processing is not applied, and/or
wherein if a height of the bottom part of the reference template is equal to a predefined number, the vertical flip processing is not applied.

13. The method of claim 10, wherein if a width of the left part of the current template is equal to a predefined number, the horizontal flip processing is not applied.

14. The method of claim 10, wherein if a height of the above part of the current template is equal to a predefined number, the vertical flip processing is not applied.

15. The method of claim 3, wherein if a horizontal flip processing is applied, samples in an above part of the reference template are derived as:
temp[x+y*tempW]=cur[curW−1−x+(y−tempH)*curStride], and
wherein temp represents a sample buffer of the above part of the reference template, (tempW, tempH) represents width and height of the above part of the reference template, (x,y) represents a location of a top-left sample of the above part of the reference template relative such part of the reference template, cur represents the sample buffer of the video unit, (curW, curH) represents width and height of the video unit, curStride represents a stride of the sample buffer of the video unit, or
wherein if a horizontal flip processing is applied, samples in a right part of the reference template are derived as:
temp[x+y*tempW]=cur[curW+tempW−1−x+y*curStride], and
wherein temp represents a sample buffer of the right part of the reference template, (tempW, tempH) represents width and height of the right part of the reference template, (x,y) represents a location of a top-left sample of the right part of the reference template relative such part of the reference template, cur represents the sample buffer of the video unit, (curW, curH) represents width and height of the video unit, curStride represents a stride of the sample buffer of the video unit, or
wherein if a vertical flip processing is applied, samples in a bottom part of the reference template are derived as:
temp[x+y*tempW]=cur[x+(curH+tempH−1−y)*curStride]], and
wherein temp represents a sample buffer of the bottom part of the reference template, (tempW, tempH) represents width and height of the bottom part of the reference template, (x,y) represents a location of a top-left sample of the bottom part of the reference template relative such part of the reference template, cur represents the sample buffer of the video unit, (curW, curH) represents width and height of the video unit, curStride represents a stride of the sample buffer of the video unit, or
wherein if a vertical flip processing is applied, samples in a left part of the reference template are derived as:
temp[x+y*tempW]=cur[x−tempW+(curH−1−y]*curStride], and
wherein temp represents a sample buffer of the left part of the reference template, (tempW, tempH) represents width and height of the left part of the reference template, (x,y) represents a location of a top-left sample of the left part of the reference template relative such part of the reference template, cur represents the sample buffer of the video unit, (curW, curH) represents width and height of the video unit, curStride represents a stride of the sample buffer of the video unit.

16. The method of claim 3, wherein if a horizontal flip processing is applied, samples in an above part of the current template are derived as:
temp[x+y*tempW]=cur[curW−1−x+(y−tempH)*curStride], and
wherein temp represents a sample buffer of the above part of the current template, (tempW, tempH) represents width and height of the above part of the current template, (x,y) represents a location of a top-left sample of the above part of the current template relative such part of the current template, cur represents the sample buffer of the video unit, (curW, curH) represents width and height of the video unit, curStride represents a stride of the sample buffer of the video unit, or
wherein if a horizontal flip processing is applied, samples in a right part of the current template are derived as:
temp[x+y*tempW]=cur[curW+tempW−1−x+y*curStride], and
wherein temp represents a sample buffer of the right part of the current template, (tempW, tempH) represents width and height of the right part of the current template, (x,y) represents a location of a top-left sample of the right part of the current template relative such part of the current template, cur represents the sample buffer of the video unit, (curW, curH) represents width and height of the video unit, curStride represents a stride of the sample buffer of the video unit, or
wherein if a vertical flip processing is applied, samples in a bottom part of the current template are derived as:
temp[x+y*tempW]=cur[x+(curH+tempH−1−y)*curStride]], and
wherein temp represents a sample buffer of the bottom part of the current template, (tempW, tempH) represents width and height of the bottom part of the current template, (x,y) represents a location of a top-left sample of the bottom part of the current template relative such part of the current template, cur represents the sample buffer of the video unit, (curW, curH) represents width and height of the video unit, curStride represents a stride of the sample buffer of the video unit, or
wherein if a vertical flip processing is applied, samples in a left part of the current template are derived as:
temp[x+y*tempW]=cur[x−tempW+(curH−1−y]*curStride], and
wherein temp represents a sample buffer of the left part of the current template, (tempW, tempH) represents width and height of the left part of the current template, (x,y) represents a location of a top-left sample of the left part of the current template relative such part of the current template, cur represents the sample buffer of the video unit, (curW, curH) represents width and height of the video unit, curStride represents a stride of the sample buffer of the video unit.

17. The method of claim 1, wherein the conversion includes encoding the video unit into the bitstream, or wherein the conversion includes decoding the video unit from the bitstream.

18. An apparatus for video processing comprising a processor and a non-transitory memory with instructions thereon, wherein the instructions upon execution by the processor, cause the processor to:
determine, for a conversion between a video unit of a video and a bitstream of the video, whether a template based processing is applied to the video unit, wherein the template based processing is based on at least one template in at least one of: a current picture or a reference picture of the video unit; and
perform the conversion based on the determining.

19. A non-transitory computer-readable storage medium storing instructions that cause a processor to:
determine, for a conversion between a video unit of a video and a bitstream of the video, whether a template based processing is applied to the video unit, wherein the template based processing is based on at least one template in at least one of: a current picture or a reference picture of the video unit; and
perform the conversion based on the determining.

20. A non-transitory computer-readable recording medium storing a bitstream of a video which is generated by a method performed by an apparatus for video processing, wherein the method comprises:
determining whether a template based processing is applied to a video unit of the video, wherein the template based processing is based on at least one template in at least one of: a current picture or a reference picture of the video unit; and
generating the bitstream based on the determining.
